(19) United States
(12) Patent Application Publication
(10) Pub. No.: US 2026/0178629 A1
(43) Pub. Date: Jun. 25, 2026

(54) RETRIEVAL MODEL TRAINING METHOD AND APPARATUS, AND COMPUTER DEVICE

(71) Applicant: Tencent Technology (Shenzhen) Company Limited, Shenzhen (CN)

(72) Inventor: Xiaoyang CHEN, Shenzhen (CN)

(21) Appl. No.: 19/538,819

(22) Filed: Feb. 12, 2026

Related U.S. Application Data
(63) Continuation of application No. PCT/CN2024/112266, filed on Aug. 15, 2024.

(30) Foreign Application Priority Data
Nov. 15, 2023 (CN) 202311529043.4

(51) Int. Cl. G06F 16/3329; G06F 16/334; G06F 16/34

(52) U.S. Cl. CPC G06F 16/33295; G06F 16/3344; G06F 16/345

(57) ABSTRACT

This application relates to a retrieval model training method performed by a computer device. The method includes: performing text segmentation processing on knowledge document, to obtain a text chunk set; performing question writing on each text chunk based on the text chunk set and the general information included in each text chunk, to obtain one or more question texts corresponding to each text chunk; combining the one or more question texts corresponding to each text chunk with the corresponding text chunk separately, to obtain one or more data pairs corresponding to each text chunk; and generating a data pair set based on the one or more data pairs corresponding to each text chunk; and training a first retrieval model by using the data pair set, to obtain a second retrieval model.

### CROSS-REFERENCE TO RELATED APPLICATIONS

This application is a continuation application of PCT Patent Application No. PCT/CN2024/112266, entitled “RETRIEVAL MODEL TRAINING METHOD AND APPARATUS, AND COMPUTER DEVICE” filed on Aug. 15, 2024, which claims priority to Chinese Patent Application No. 2023115290434, entitled “MODEL TRAINING METHOD AND APPARATUS, DEVICE, MEDIUM, AND PROGRAM PRODUCT” and filed on Nov. 15, 2023, all of which are incorporated herein by reference in their entirety.

### FIELD OF THE TECHNOLOGY

This application relates to the field of computer technologies, and in particular, to the field of artificial intelligence, and in particular, to a retrieval model training method, a retrieval model training apparatus, a computer device, a computer readable storage medium, and a computer program product.

### BACKGROUND OF THE DISCLOSURE

Intelligent question-answering refers to a process of answering, by using an accurate and concise natural language, a question raised by a user, and belongs to the field of natural language processing (NLP), which attracts much attention and has a wide development prospect.

Currently, retrieval of an answer of a user question from a retrieval library in an intelligent question-answering process is supported by using a retrieval model. It is found through practice that answer retrieval performance of an existing retrieval model is poor, and data of the retrieval library is of poor quality. Consequently, in the intelligent question-answering process, the retrieval model cannot provide an accurate and meticulous answer of the user question.

### SUMMARY

Embodiments of this application provide a retrieval model training method and apparatus, a computer device, a computer readable storage medium, and a computer program product.

A retrieval model training method is performed by a computer device, and the method includes:
performing text segmentation processing on a knowledge document, to obtain a text chunk set, the text chunk set comprising a plurality of text chunks, each text chunk being formed by one reference text chunk belonging to the knowledge document and general information corresponding to the reference text chunk;
performing question writing on each text chunk based on the text chunk set and the general information included in each text chunk, to obtain one or more question texts corresponding to the text chunk;
combining the one or more question texts corresponding to each text chunk with the corresponding text chunk separately, to obtain one or more data pairs corresponding to each text chunk;
generating a data pair set based on the one or more data pairs corresponding to each text chunk, each data pair being formed by one question text and one text chunk that are matched, and a text chunk in each data pair being used as an answer source of a question text matching the text chunk; and
training a first retrieval model by using the data pair set, to obtain a second retrieval model, the second retrieval model corresponding to a retrieval library, the retrieval library comprising a feature vector of each text chunk in the text chunk set configured for generating a first answer for a first question text matching the text chunk in an interactive dialog scenario.

A computer device includes a memory and one or more processors, where the memory stores computer readable instructions, when executed by the one or more processors, causing the computer device to perform the operations of the retrieval model training method.

One or more non-transitory computer readable storage media have computer readable instructions stored therein, when executed by one or more processors of a computer device, causing the computer device to perform the operations of the retrieval model training method.

Details of one or more embodiments of this application are provided in the accompanying drawings and descriptions below. Other features, objectives, and advantages of this application become apparent from the specification, the accompanying drawings, and the claims.

### BRIEF DESCRIPTION OF THE DRAWINGS

To describe technical solutions in embodiments of this application or the conventional technology more clearly, the following briefly introduces the accompanying drawings required for describing the embodiments or the conventional technology. Apparently, the accompanying drawings in the following description show only embodiments of this application, and a person of ordinary skill in the art may still derive other drawings from the accompanying drawings without creative efforts.

FIG. 1 is a schematic diagram of an intelligent question-answering scenario according to an exemplary embodiment of this application.

FIG. 2 is a schematic diagram of another intelligent question-answering scenario according to an exemplary embodiment of this application.

FIG. 3 is a schematic diagram of still another intelligent question-answering scenario according to an exemplary embodiment of this application.

FIG. 4 is a schematic flowchart of model training according to an exemplary embodiment of this application.

FIG. 5 is a schematic flowchart of a model training method according to an exemplary embodiment of this application.

FIG. 6 is a schematic flowchart of text segmentation processing according to an exemplary embodiment of this application.

FIG. 7 is a schematic diagram of an effect of text segmentation according to an exemplary embodiment of this application.

FIG. 8 is a schematic diagram of key-value pair check according to an exemplary embodiment of this application.

FIG. 9 is a schematic flowchart of text segmentation, key-value pair generation and verification according to an exemplary embodiment of this application.

FIG. 10 is a schematic diagram of text allocation according to an exemplary embodiment of this application.

FIG. 11 is a schematic diagram of another text allocation according to an exemplary embodiment of this application.

FIG. 12 is a schematic flowchart of model application according to an exemplary embodiment of this application.

FIG. 13 is a schematic flowchart of another model training method according to an exemplary embodiment of this application.

FIG. 14 is a schematic diagram of intelligent question-answering interaction according to an exemplary embodiment of this application.

FIG. 15 is a schematic diagram of matching a feature vector of a first question text against a retrieval library in a model application process according to an exemplary embodiment of this application.

FIG. 16 is a schematic structural diagram of a model training apparatus according to an exemplary embodiment of this application.

FIG. 17 is a schematic structural diagram of a computer device according to an exemplary embodiment of this application.

### DESCRIPTION OF EMBODIMENTS

The technical solutions in embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without making creative efforts shall fall within the protection scope of this application.

In embodiments of this application, a retrieval model training solution is provided, and specifically, a model training and application solution of a retrieval model based on artificial intelligence and intelligent question-answering is provided. The following briefly describes related concepts involved in the retrieval model training solution provided in embodiments of this application.

Intelligent question-answering may be referred to as open question-answering, interactive dialog, or the like, belongs to the field of human computer interaction, and is an advanced form of an information retrieval system; and mainly intends to receive a question of a user by using a computer device, and answer, by using an accurate and concise natural language, the question raised by the user. With the rapid development and application of artificial intelligence (AI), an intelligent question-answering technology becomes a direction that attracts much attention and has a wide development prospect in the field of nature language processing (NLP). An intelligent question-answering system mainly includes three parts: question understanding, knowledge retrieval, and answer generation. Question understanding mainly includes technologies such as question classification and keyword extraction, aiming to enable a computer device to understand semantics of a to-be-answered question inputted by a user. Knowledge retrieval mainly includes structured and non-structured information retrieval, and is intended to retrieve, from a database by using an understood question, a knowledge point matching the to-be-answered question inputted by the user. Answer generation mainly includes answer extraction and answer verification, and is intended to generate a corresponding answer for the to-be-answered question from the knowledge point retrieved from knowledge. A core question of the intelligent question-answering technology is to process understanding of a question and a matching degree between the question and an answer.

In actual application, the intelligent question-answering system has problems such as a low question-answering matching degree, resulting in poor retrieval performance and low answer accuracy. For example, the intelligent question-answering system cannot precisely record information in a corpus (that is, a language corpus) because of a lack of related vertical knowledge in a field. Therefore, in a vertical application, a specific question (for example, inquiring whether an insurance product can protect against a particular condition, the intelligent question-answering system does not have related field knowledge, and answers thereof are hallucinations (that is, fictive answers of the intelligent question-answering system) and are not correct answers) cannot be directly answered. To improve retrieval performance of the intelligent question-answering system and improve accuracy of answer retrieval, the retrieval model training solution provided in embodiments of this application is mainly for a vertical scenario, and combines application of a strong text understanding capability of a generative pre-trained transformer (GPT) and a local retrieval method of a conventional dense passage retrieval (PPR) algorithm, a new intelligent question-answering system is formed that encompasses retrieval library generation, training, recall, and a plurality of turns of question-answering.

The core content of the retrieval model training solution provided in embodiments of this application may include creation, update, and application of a retrieval library (that is, the retrieval library is applied to retrieve an answer in an intelligent question-answering process). Creating the retrieval library may be a process of training a second retrieval model for a first retrieval model based on a language corpus in a vertical field, and constructing the retrieval library based on the second retrieval model and the language corpus. Updating of the retrieval library may refer to designing a metadata structure of a corpus, so as to conveniently implement operations such as adding, reducing, or replacement of data for the retrieval library. Application of the retrieval library may include, but is not limited to, universal question processing (for example, single-round question retrieval) based on the second retrieval model and the retrieval library, user-customized question processing (for example, multi-round question retrieval), and the like. Main key technologies and innovative methods of the retrieval model training solution are briefly introduced below:

### (1) Construction of the Second Retrieval Model and the Retrieval Library.

The second retrieval model is a retrieval model obtained by training the first retrieval model by using training data, and the first retrieval model is a to-be-trained model before training. The retrieval library may be simply understood as a database that stores text chunks of answer sources in an intelligent question-answering system.

Construction of the second retrieval model and the retrieval library mainly includes: text segmentation, data pair construction, and retrieval model training. Specifically, first, a knowledge document in a vertical field is obtained. The knowledge document may be understood as a large quantity of corpora belonging to the vertical field. In this way, text segmentation processing (such as form conversion, knowledge summarization, document segmentation, and document summarization) may be performed on the knowledge document by using a full text understanding capability, a summarization capability, and the like of the GPT model, to obtain a text chunk set (or referred to as a search text chunk set). The text chunk set includes a plurality of text chunks, each text chunk has a single topic, and each text chunk is formed by one reference text chunk belonging to the knowledge document and general information corresponding to the reference text chunk. The general information is obtained by summarizing text semantics of the corresponding reference text chunk. Then, by using a content digest capability, an innovative writing capability, and the like of the GPT model, one or more data pairs (or referred to as key-value pairs) corresponding to each text chunk are constructed according to a key element of each text chunk in the text chunk set. Language styles of different data pairs corresponding to the same text chunk may be different, a question text in each data pair is obtained by performing question writing on a text chunk matching the question text, and the text chunk in each data pair is used as an answer source of the question text matching the text chunk. Next, quality check is performed on the data pair corresponding to each text chunk by using a content screening capability of a large language model (LLM), a dialog and communication capability, and the like, to obtain a data pair set formed by data pairs meeting a quality requirement, so as to ensure that a text chunk can cover an answer of a question, that is, ensure that the text chunk in the data pair is an answer source of a corresponding question text, and position information of an answer of the question text can be positioned in the text chunk. Finally, retrieval model training is performed on the first retrieval model by using the data pair set, to obtain a trained second retrieval model and retrieval library.

In addition, when the text chunk set is constructed, the text chunk is further stored by using a metadata structure, so as to manage the retrieval library, for example, update the retrieval library, by using the metadata structure. The metadata, also referred to as intermediate data or relay data, is data about data, mainly describes information about a data property, and is configured for supporting functions such as indicating a storage position, historical data, resource searching, and file recording. In this way, by designing the metadata structure for the text chunk, associative search, search priority, and convenience of operations such as adding, reducing, or replacement of the retrieval library can be implemented. Content such as updating of the retrieval library and associative searching of the text chunk based on the metadata is described in detail in subsequent specific embodiments, and only brief descriptions are provided herein.

### (2) Processing of a Universal Question-Application of the Retrieval Library.

After the second retrieval model and the retrieval library are constructed based on the foregoing implementation (1), in an actual retrieval process, if an object has a requirement for retrieving an answer of a question, the object may input a first question text to the intelligent question-answering system, and the intelligent question-answering system invokes the second retrieval model to perform vector embedding processing on the first question text, to obtain a vector representation (or referred to as a feature vector) of the first question text. In this way, the intelligent question-answering system may perform similarity matching on the vector representation of the first question text and a feature vector of each of a plurality of text chunks already stored in the retrieval library, to match a plurality of text chunks for the first question text, so as to generate a matched first answer for the first question text based on the plurality of text chunks.

### (3) Processing of a User-Customized Question-Application of the Retrieval Library.

In a multi-round question-answering scenario, in embodiments of this application, historical object data about an object is constructed based on historical dialog data of the object. The historical object data may represent query content, a query direction, a query style, and the like of the object to some extent. In this way, historical object data is extracted and slot filling is performed in each round of dialog by using the GPT model, to keep refreshing of the object data, to keep accuracy and timeliness of the object data, and to match an object status in real time, thereby facilitating personalized recommendation and customized question consultation for the object.

It can be learned that, on one hand, according to the retrieval model training solution provided in embodiments of this application, text chunk quality is ensured by ensuring a single topic and general information of the text chunk during text segmentation. In addition, a matched question is directly generated based on a text chunk to construct a data pair, thereby effectively improving authenticity and data quality of the data pair. The data quality is embodied in that an answer of a question text certainly can be extracted from the text chunk. In this way, when the retrieval model is trained based on the data pair with relatively good quality, the retrieval model is trained in a direction that ensures that a feature difference of the same data pair decreases, so that the retrieval model has a relatively good feature representation capability for both the question text and the text chunk, thereby obtaining a second retrieval model with a relatively good vector expression capability and a retrieval library with relatively good data quality. On the other hand, rich functions of the GPT model are fully used in embodiments of this application. A universal question (that is, a question in a single round of question-answering) and a user-customized question (that is, a question in a plurality of rounds of question-answering) are efficiently processed by constructing a universal retrieval library and by means of a GPT-based real-time object data capturing synchronization mechanism. For the universal question, an answer is retrieved after similarity calculation is performed on a question of an object and a feature vector of a text chunk in a retrieval library (specifically, a text chunk is retrieved, and an answer is generated based on the text chunk). For the user-customized question, object data of an object is extracted by using the GPT model, and conditional retrieval is performed based on the object data and a first question text of the object, to implement personalized question-answering for different objects, thereby improving accuracy of an intelligent question-answering system and experience of object question retrieval.

The intelligent question-answering system provided in embodiments of this application is used as an automatic question-answering solution based on an artificial intelligence technology, and may understand, parse, and answer a question raised by a user. In this way, the retrieval model training solution provided in embodiments of this application may be applied to a plurality of interactive dialog scenarios in which querying needs to be implemented by using the intelligent question-answering system. The interactive dialog scenario may include, but is not limited to: \textcircled{1} Customer support: An intelligent question-answering AI system may be used as a customer support tool, and is configured for answering common questions of users, reducing a work burden of customer service personnel, and improving customer satisfaction. \textcircled{2} Enterprise internal knowledge base: An enterprise may construct an internal knowledge base by using an intelligent question-answering AI system, to help enterprise employees rapidly find needed information, thereby improving working efficiency. \textcircled{3} Virtual assistant: An intelligent question-answering AI system may be used as a virtual assistant of an individual or an enterprise, and provide functions such as daily task management, scheduling, and reminding services. \textcircled{4} Online education: An intelligent question-answering AI system may be applied to the field of online education, to provide a personalized learning resource and a real-time question-answering service for students. \textcircled{5} Electronic commerce: An intelligent question-answering AI system may help a user answer questions during shopping, provide shopping suggestions, and improve shopping experience. \textcircled{6} Financial service: An intelligent question-answering AI system may provide a real-time consultation service for customers of financial institutions such as banks and insurance companies, to answer questions about accounts, transactions, products, and the like. \textcircled{7} Medical consultation: An intelligent question-answering AI system may provide a basic medical consultation service for a patient, and answer questions about a disease, treatment, a medicine, and the like. \textcircled{8} Travel consultation: An intelligent question-answering AI system may provide real-time travel information for tourists, and answer questions about scenic spots, hotels, transportation, and the like. \textcircled{9} News and information retrieval: An AI question-answering system may help a user quickly find needed news and information, thereby improving information retrieval efficiency.

The foregoing descriptions are merely example product representation and interactive dialog scenarios provided in embodiments of this application, and do not limit the product representation and interactive dialog scenarios of the retrieval model training solution provided in embodiments of this application. The intelligent question-answering system provided in embodiments of this application can provide efficient, accurate, and convenient question-answering services in various interactive dialog scenarios, and shows high value and practicability in various interactive dialog scenarios, thereby helping improve user experience and satisfaction.

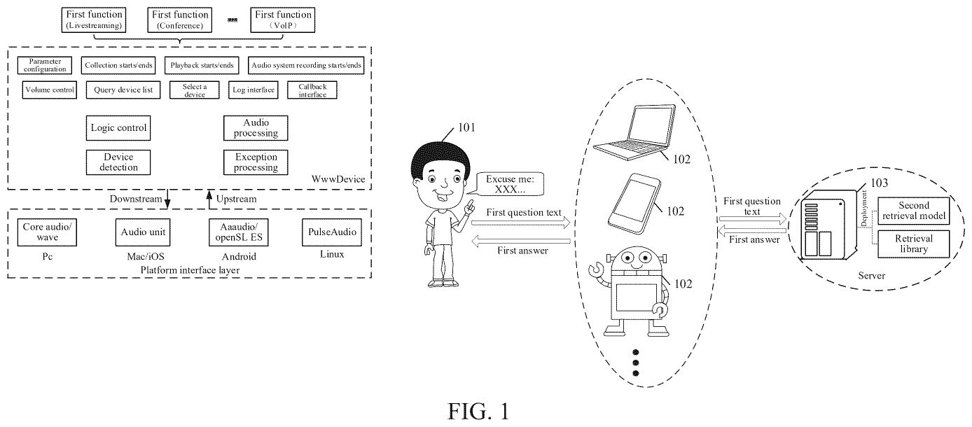

For ease of understanding the retrieval model training solution provided in embodiments of this application, the following briefly describes an interactive dialog scenario in an embodiment of this application with reference to a schematic scenario diagram shown in FIG. 1. As shown in FIG. 1, the system includes an object 101, a terminal 102, and a server 103. Quantities and names of the object 101, the terminal 102, and the server 103 are not limited in this embodiment of this application.

The terminal 102 may be a terminal device having an interactive dialog function, and the object 101 may perform a single round or a plurality of rounds of interactive dialogs with the terminal 102, to obtain related knowledge. The terminal 102 may include but is not limited to a terminal device such as a smartphone (such as a smartphone deployed with an Android system or a smartphone deployed with an Internetworking operating system (IOS)), a tablet computer, a portable personal computer, a mobile Internet device (MID), an in-vehicle device, a headset device, an intelligent chat robot, and an aircraft. A type of the terminal device is not limited in this embodiment of this application as described herein. The server 103 is a server corresponding to the terminal 102, and is configured to perform data interaction with the terminal 102 to provide calculation and application service support for the terminal 102. The server 103 may be an independent physical server, or may be a server cluster or a distributed system formed by a plurality of physical servers, or may be a cloud server that provides basic cloud computing service such as a cloud service, a cloud database, cloud computing, a cloud function, cloud storage, a network service, cloud communication, a middleware service, a domain name service, a security service, a content distribution network (CDN), big data, and an artificial intelligence platform. The terminal 102 and the server 103 may be directly or indirectly connected in a wired or wireless communication protocol. This is not limited in this application.

During specific implementation, a retrieval model training object is supported to obtain knowledge documents in a vertical scenario/field (such as education, medical treatment, insurance, entertainment, banking, and real estate) from different platforms or systems by using the server 103 through a network. Then, the server 103 may sequentially perform operations such as document segmentation processing, constructing a data pair set, training a model, and constructing a retrieval library on the knowledge document according to the retrieval model training solution provided in embodiments of this application, to obtain a trained second retrieval model and retrieval library.

Further, the trained second retrieval model and retrieval library may be directly deployed on the server 103. In this way, when an object initiates an interactive dialog by using the terminal 102, a first question text of the object may be sent, by using the terminal 102, to the server 103 on which the trained second retrieval model is deployed. In this way, the server 103 performs vector embedding processing on the first question text by using the trained second retrieval model, to obtain a vector representation of the first question text, so that the server 103 can retrieve, from the retrieval library based on the vector representation of the first question text, one or more text chunks matching the vector representation of the first question text, and generate a corresponding first answer for the first question text based on the one or more text chunks. Finally, the server 103 delivers the first answer to the terminal 102, so that the object can obtain the first answer about the first question text by using the terminal 102.

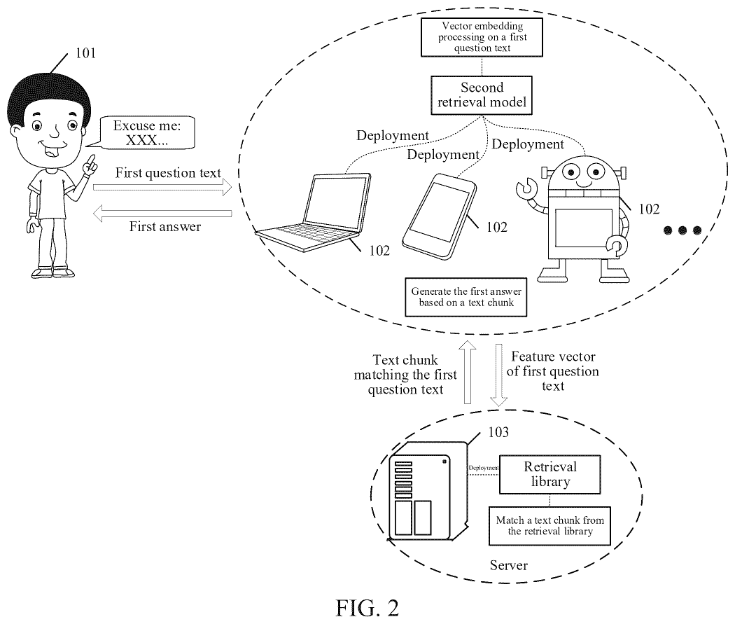

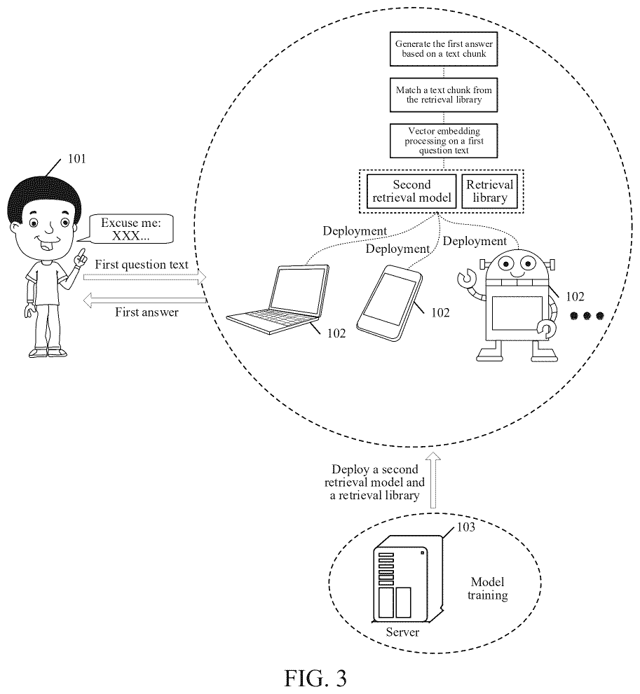

Certainly, the trained second retrieval model may alternatively be deployed in the terminal 102, and the interactive dialog process varies according to different deployment positions of the retrieval library. In some embodiments, as shown in FIG. 2, when the retrieval library is maintained by the server 103, after receiving the first question text of the object and invoking the deployed second retrieval model to perform vector embedding processing on the first question text, to obtain the vector representation of the first question text, the terminal 102 may transmit the vector representation to the server 103. The server 103 retrieves, based on the vector representation of the first question text, one or more text chunks matching the vector representation of the first question text from the retrieval library. Then, the server 103 may return the one or more text chunks to the terminal 102, so that the terminal 102 generates a corresponding first answer for the first question text based on the one or more text chunks and outputs the corresponding first answer. The foregoing described process of generating the corresponding first answer for the first question text based on the one or more text chunks may alternatively be performed by the server 103. In this case, the server 103 directly outputs the first answer to the terminal 102 for presentation, which can relieve the burden of the terminal 102 to some extent. In some embodiments, as shown in FIG. 3, when the retrieval library is maintained by the terminal 102, after receiving the first question text of the object, and invoking the deployed second retrieval model to perform vector embedding processing on the first question text, to obtain the vector representation of the first question text, the terminal 102 may directly retrieve, based on the vector representation of the first question text, one or more text chunks matching the vector representation of the first question text from the retrieval library, generate a corresponding first answer for the first question text based on the one or more text chunks, and output the corresponding first answer.

Further, the trained second retrieval model may be deployed in the terminal 102 in a form of a plug-in or an application program. For example, the trained second retrieval model is deployed in the terminal 102 as a system-level plug-in, and then any application program deployed in the terminal 102 may invoke the plug-in to implement an interactive dialog, to provide the first answer of the first question text of the object. For another example, the trained second retrieval model is deployed in an application program, and after the application program is started by using the terminal 102, the trained second retrieval model may be invoked in the application program to implement an interactive dialog. The application program may be a computer program that completes one or more particular jobs. The application program is classified according to different dimensions (such as a running manner and a function of the application program), and types of the same application program in different dimensions may be obtained. For example, application programs are classified according to running manners of the application programs. The application programs may include, but are not limited to: a client installed in a terminal, a mini program (as a subprogram of a client) that can be used without being downloaded and installed, a world wide web (WEB) application program opened by using a browser, and the like. For another example, application programs are classified according to function types of the application programs. The application programs may include, but are not limited to, an instant messaging (IM) application program, a content interaction application program, and the like. The instant messaging application program refers to an application program that instantly exchanges messages and performs social interaction based on the Internet. The instant messaging application program may include, but is not limited to, a social application program that includes a communication function, a map application program that includes a social interaction function, a game application program, and the like. The content interaction application program is an application program that can implement content interaction, and may be, for example, an application program such as Internet banking, a sharing platform, a personal space, or news. A specific type of the application program that runs on the terminal 102 and on which the trained second retrieval model is deployed is not limited in this embodiment of this application, as described herein.

FIG. 1, FIG. 2, and FIG. 3 are merely schematic diagrams of example scenario architectures according to embodiments of this application. In an actual application, the architecture may adaptively change.

Collection and processing of related data in embodiments of this application need to strictly comply with the requirements of relevant laws and regulations. Acquisition of personal information need to be topic to the knowledge or consent of a personal topic (or the legal basis for acquiring the information), and subsequent use and processing of data is carried out within the scope of authorization of laws and regulations and the topic of the person information. For example, when embodiments of this application are applied to a specific product or technology, for example, when obtaining the first question text of the object, permission or consent of the user needs to be obtained, and related data collection, use, and processing (for example, collection and release of a bullet-screen comment released by the object) need to comply with relevant laws and regulations and standards of a related region.

Based on the foregoing retrieval model training solution, embodiments of this application provide a more detailed retrieval model training method. The following describes the retrieval model training method provided in embodiments of this application in detail with reference to the accompanying drawings. It can be known from the foregoing related descriptions that the retrieval model training method provided in embodiments of this application mainly includes two parts: retrieval model training and model application for a retrieval model. The retrieval model training part further includes construction of a retrieval library. For ease of understanding, different embodiments are used subsequently to respectively describe specific implementation processes of retrieval model training and model application.

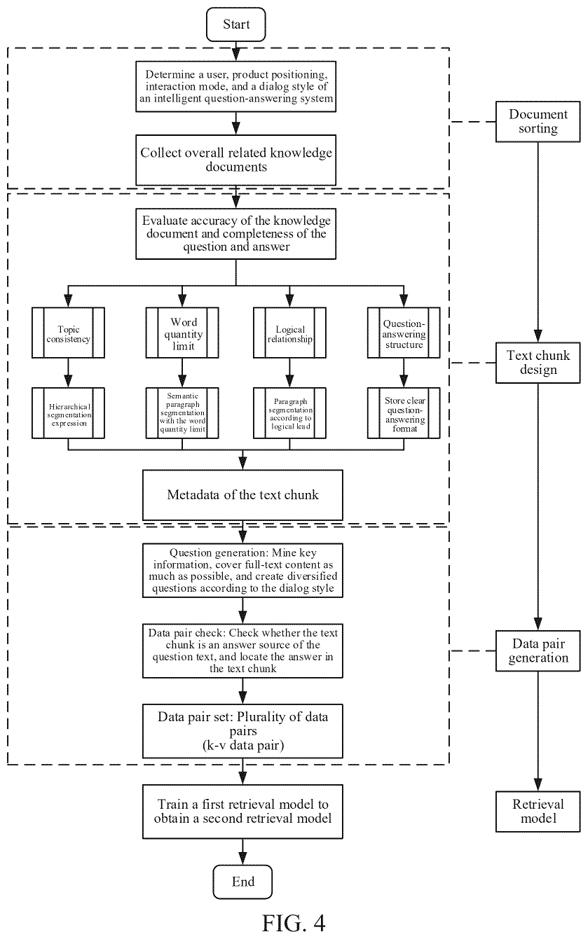

Referring to FIG. 4, FIG. 4 is a schematic flowchart of a retrieval model training method according to an exemplary embodiment of this application. The schematic flowchart mainly provides an overall training procedure of retrieval model training from the perspective of retrieval model training. As shown in FIG. 4, an approximate procedure of the retrieving model training method may include the following operations:

First, scenario information of an interactive dialog scenario is determined according to a type of an intelligent question-answering system (such as an intelligent robot in a shopping mall, a meal transmitting robot for food and beverage, or a querying robot for insurance). Then, a knowledge document related to the scenario information is collected and arranged according to the scenario information of the interactive dialog scenario, and is used as a corpus for retrieval model training and a retrieval library, to overcome a disadvantage that a GPT model cannot accurately record and recommend information without related knowledge of a vertical scenario. The scenario information of the interactive dialog scenario may include, but is not limited to: \textcircled{1} a function position (or referred to as an interaction field) of an intelligent question-answering system, mainly including a product position and a user group. In this way, a question objective and a question-raising angle of the intelligent question-answering system can be determined according to the function position. For example, for an intelligent insurance consultation AI question-answering product, a user group having a query requirement needs to be located as users who need to purchase insurance and question the insurance product. \textcircled{2} An interaction style, or referred to as a dialog style, mainly refers to a type or style related to a question during human computer interaction. The dialog style may include at least one of the following: a factual style (or referred to as a factual question, meaning that an intelligent question-answering system needs to answer, according to an actual fact situation, a question raised by a user), an explanatory style (or referred to as an explanatory question, meaning that an intelligent question-answering system needs to explain a question raised by a user), a reasoning style (or referred to as a reasoning question, meaning that an intelligent question-answering system needs to have a certain reasoning capability to answer a question raised by a user), an evaluative style (or referred to as an evaluative question, meaning that an intelligent question-answering system needs to make an evaluative answer to a point in a question raised by a user), and an assumption style (or referred to as an assumption question, meaning that an intelligent question-answering system needs to answer, in an assumed manner, a question raised by a user). \textcircled{3} An interaction manner is a dialog manner used in a human computer interaction process. For example, an interaction manner between a user and an intelligent question-answering system may include, but is not limited to, a text-voice interaction manner, a text-text interaction manner, a voice-voice interaction manner, a voice-text interaction manner, and the like. For example, the text-voice interaction manner indicates that a user may input a question of the user in a form of text in the intelligent question-answering system, and when answering the question raised by the user, the intelligent question-answering system plays the answer in a voice broadcasting manner.

Then, document precision and question-answering completeness are determined for a knowledge document by using the GPT model. Specifically, operations such as document segmentation (or referred to as segmentation), rewriting, and summarization are performed on the knowledge document, to segment the complete knowledge document into manageable segments (which may be referred to as text chunks in embodiments of this application) that can be separately processed. In this way, it is beneficial to separately processing a text chunk having a limited length, and management on the text chunk is greatly facilitated. Logic that is supported by embodiments of this application and that is for determining document precision and question-answering completeness of the knowledge document may roughly include: \textcircled{1} Topic consistency: text chunks are extracted according to topics. That is, it needs to be ensured that each segmented text chunk has one topic, to ensure a single topic of the text chunk, so that each text chunk has an advantage of clear topic. \textcircled{2} Limitation of a word count: Considering that a length of an input text that can be accepted by the GPT model is limited, an excessively long or excessively large knowledge base cannot be accepted, and a specific question cannot be directly answered in a vertical application. Therefore, this application needs to ensure that a character quantity of characters included in each text chunk obtained through segmentation is less than a quantity threshold. The quantity threshold is specifically determined by a quantity of words allowed by the GPT model. \textcircled{3} Logical relationship: Embodiments of this application support summarizing text semantics of each reference text chunk (that is, directly obtained by segmentation from the knowledge document) according to a text logical relationship (such as a general-to-specific relationship or a parallel relationship) of the knowledge document, to obtain general information of each reference text chunk, and adding the general information to a corresponding reference text chunk to obtain a text chunk. In this way, semantics of each text chunk in the knowledge document can be clarified, and clearness of an overall logical relationship of the knowledge document can be improved. \textcircled{4} Question-answering structure: In embodiments of this application, a text chunk whose original structure is the question-answering structure is supported to be directly stored in a form of the question-answering structure, and subsequently, question generalization may be directly performed by using the text chunk of the question-answering structure, to generate a question variant corresponding to the text chunk of the question-answering structure, thereby improving richness of a data pair, and gradually improving retrieval accuracy. It can be seen that, in embodiments of this application, a text chunk is designed for a knowledge document related to a vertical category by using a language capability of the GPT model for the first time, and a new text segmentation manner is provided, so that text chunks have advantages such as the same important knowledge point, complete information, clear topic, and clear logic, which not only ensures coherence, completeness, and association between text chunks, but also greatly improves data quality of a retrieval library.

Further, after the knowledge document is segmented to obtain a plurality of text chunks based on the foregoing operations, in embodiments of this application, a metadata structure is stored for each document chunk, to facilitate subsequent update of the retrieval library based on the metadata. In addition, question generation is also supported for each text chunk. Specifically, the text chunk is used as an answer source, and one or more question texts matching the text chunk are generated, so that each question text is combined with the text chunk to obtain a data pair, thereby obtaining one or more data pairs corresponding to each text chunk. One data pair includes one question text and one text chunk, the question text is generated based on the text chunk, and the text chunk is an answer source of the question text. Further, after the one or more data pairs corresponding to each text chunk are obtained, to ensure that each data pair is not hallucination (that is, false construction by the GPT model), in embodiments of this application, key-value pair verification further needs to be performed on each data pair, to ensure that each data pair obtained through verification exists truthfully, thereby improving authenticity and reliability of a corpus of retrieval model training and the retrieval library.

Finally, retrieval model training is performed on the first retrieval model by using the plurality of data pairs (belonging to the data pair set) obtained after the foregoing processing, to obtain a trained first retrieval model (referred to as a second retrieval model in embodiments of this application) and retrieval library. A manner of determining the retrieval library may specifically include: in some embodiments, obtaining a feature vector of a text chunk obtained by performing vector embedding processing on a text chunk in each data pair in a last iterative training process of a retrieval model training process, and adding the feature vector of the text chunk to the retrieval library after deduplication processing is performed on the feature vector of the text chunk. In some embodiments, vector embedding processing is performed, by using the second retrieval model, on each text chunk obtained after the foregoing text segmentation processing, and an obtained feature vector of the text chunk is added to the retrieval library.

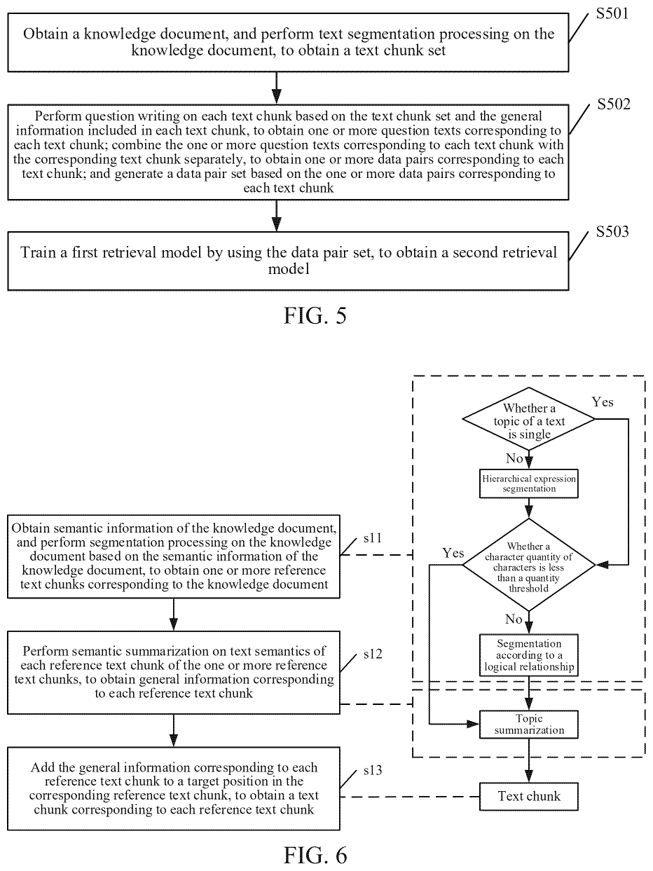

Based on the brief description of the overall procedure of retrieval model training in FIG. 4, the following describes a specific implementation process of retrieval model training in detail with reference to FIG. 5. FIG. 5 is a schematic flowchart of a model method according to an exemplary embodiment of this application. A procedure of the retrieval model training method shown in FIG. 5 is mainly a procedure of retrieval model training of a retrieval model and construction of a retrieval library. The retrieval model training method may be performed by a computer device. The computer device may be the server 103 shown in FIG. 1. The retrieval model training method may include but is not limited to operations S501 to S503.

S501: Obtain a knowledge document, and perform text segmentation processing on the knowledge document, to obtain a text chunk set.

As described above, the knowledge document may be understood as a large quantity of corpora belonging to a vertical field. The vertical field herein is alternatively referred to as a vertical scenario. The vertical field refers to a specialized and subdivided industry or market field. These fields usually have specific requirements, user groups, and service patterns. Compared with a wide general field, the vertical field is more focused on a specific market segment. Specifically, the vertical field may refer to a particular field/scenario, and then a knowledge document belonging to the vertical field may refer to a language corpus (a corpus for short) belonging to the particular field. For example, if the vertical scenario is an insurance scenario, the knowledge document belonging to the vertical scenario may include an insurance policy, an insurance contract, an insurance clause text, and the like related to insurance. For another example, if THE vertical scenario is a financial scenario, THE knowledge document belonging to the vertical scenario may include a deposit rule, a wealth management product description, and the like that are related to money or finance. This embodiment of this application does not limit the vertical scenario, a quantity (for example, a quantity of knowledge documents is at least one, for example, one or more insurance policies about medical insurance) and types of knowledge documents belonging to the vertical scenario. For ease of description, an example in which the vertical scenario is an insurance scenario and the knowledge document is a medical insurance policy belonging to the insurance scenario is used subsequently for description, as described herein. Further, a manner of obtaining the knowledge document is not limited in this embodiment of this application. For example, the manner of obtaining the knowledge document may include but is not limited to: obtaining, by the computer device, from a platform or a system related to the vertical scenario by using a network, or directly obtaining, by the computer device, content disclosed on the Internet.

After the knowledge document in the vertical scenario is obtained, considering that the knowledge document usually has relatively long content, for example, an insurance policy about medical insurance usually has dozens or even hundreds of pages, and a knowledge document with excessively long content usually includes many knowledge points (for example, insurance clauses about different types of diseases), if the entire knowledge document is directly configured for retrieval model training and retrieval library construction, model performance of the retrieval model and data quality of the retrieval library are low due to factors such as complex topics and a large quantity of content of the knowledge document.

Therefore, this embodiment of this application supports performing text segmentation processing on the knowledge document by using a text splitter, to segment a knowledge document having relatively long content into small chunks or segments (that is, the foregoing mentioned text chunk) having relatively low content. In this way, using a text chunk having relatively low content is more beneficial to retrieval model training and retrieval library construction. \textcircled{1} The text chunk in this embodiment of this application may be represented as a chunk. In the fields of information retrieval and natural language processing, the chunk refers to a relatively small segment or part of text. In the retrieval library, the chunk refers to segmenting a relatively large document or data set into relatively small parts that are easy to be processed and analyzed. In this way, segmenting relatively long content into chunks and then performing processing can improve retrieval and analysis efficiency, and chunks with relatively small content are convenient for extracting valuable information. \textcircled{2} The text splitter involved in this embodiment of this application is an algorithm or method for segmenting a large segment of text into smaller chunks or segments. An objective thereof is to create manageable segments (that is, text chunks) that can be processed separately, which is usually necessary when processing a large document or data set.

During specific implementation, for a schematic diagram of a principle of performing text segmentation processing on a knowledge document by using the text splitter, refer to related content of the text chunk design part shown in FIG. 4, and a specific implementation process of text segmentation processing may be shown in FIG. 5, and includes but is not limited to operations s11 to s13.

s11: Obtain semantic information of the knowledge document, and perform segmentation processing on the knowledge document based on the semantic information of the knowledge document, to obtain one or more reference text chunks corresponding to the knowledge document. The knowledge document is text content including one or more characters, and the text content may also include an image. The semantic information of the knowledge document may be configured for indicating semantics expressed by the knowledge document, such as a topic to which the knowledge document belongs, specific content described by the knowledge document, or a text type to which the knowledge document belongs. A manner of obtaining the semantic information of the knowledge document is not limited in this embodiment of this application. For example, the text splitter provided in this embodiment of this application has a semantic extraction function, and the text splitter may be directly configured for obtaining the semantic information of the knowledge document. For another example, the semantic information of the knowledge document may be extracted by using some existing semantic extraction networks (such as a bag-of-words model) or tools.

Considering that the knowledge document is usually a long text, and excessively long content affects a subsequent retrieval and summarization process, to refine knowledge points and meet a data quality requirement of a subsequent retrieval process, ensure a clear topic of a text chunk obtained through segmentation, and improve document precision of the text chunk (that is, content expressed by each text chunk is single), in this embodiment of this application, it needs to be ensured that each text chunk has only a single topic. That a text chunk has a single topic may be simply understood as that semantics expressed by the text chunk are unique rather than mixed. For example, content of the text chunk is “Go to climb a mountain tomorrow. The weather is very good today”. The text chunk includes two topics, which are respectively the topic “Go to climb a mountain tomorrow” and the topic “The weather is very good today”. Therefore, after obtaining the semantic information of the knowledge document, the text splitter determines, based on the semantic information of the knowledge document, whether the topic to which the knowledge document belongs is single.

On one hand, if the knowledge document belongs to a single topic, indicating that the knowledge document expresses only the same topic, a quantity of characters included in the knowledge document is determined, to ensure that the quantity of characters included in the text chunk obtained through segmentation meets a requirement of the text splitter, avoiding that content of the text chunk is excessively long and consequently cannot be accepted by the text splitter, and cannot meet a requirement of the retrieval library for a character quantity of a text chunk (specifically, cannot meet a requirement of the retrieval library for a length of a feature vector embedding of a stored text chunk). The knowledge document is used as a reference text chunk when the character quantity of the characters included in the knowledge document is less than a character quantity threshold. Alternatively, when the character quantity of the characters included in the knowledge document is greater than or equal to the character quantity threshold, paragraph segmentation processing is performed on the knowledge document according to a text logical relationship, to obtain a plurality of reference text chunks corresponding to the knowledge document. A specific value of the character quantity threshold is related to a category of the text splitter. For example, when the text splitter is a GPT model, it needs to be ensured that a word count of a text chunk is within 512 tokens (a token may be understood as a character unit, and one character unit may include one or more characters).

On the other hand, if there are at least two topics to which the knowledge document belongs, indicating that the topics of the knowledge document are unclear, hierarchical expression segmentation is performed on the knowledge document according to topic types, to obtain at least two initial text chunks, where the at least two initial text chunks each have one topic. Then, a character quantity of characters included in each initial text chunk of the at least two initial text chunks obtained after the hierarchical expression segmentation is counted, an initial text chunk whose character quantity is less than the character quantity threshold is used as a reference text chunk, and paragraph segmentation processing is performed on the initial text chunk whose character quantity is greater than or equal to the character quantity threshold according to the text logical relationship, to obtain a plurality of reference text chunks corresponding to the knowledge document. That is, if it is determined that the topic of the knowledge document is not single, hierarchical expression segmentation may be performed on the knowledge document according to the topic type, to obtain a plurality of initial text chunks having a single topic, a character quantity is counted for each initial text chunk, an initial text chunk whose character quantity is less than the character quantity threshold is used as a reference text chunk, and on the contrary, paragraph segmentation processing is performed on an initial text chunk whose character quantity is greater than or equal to the character quantity threshold, to obtain a plurality of reference text chunks corresponding to the knowledge document.

The knowledge document is segmented a plurality of times from dimensions of topic consistency and character quantity requirements, to obtain a plurality of reference text chunks corresponding to the knowledge document, so that each reference text chunk obtained through segmentation has features such as that the reference text chunk has the same important knowledge point (for example, a single topic), and a character quantity is less than the character quantity threshold. In this way, when subsequent data pair construction and retrieval library construction are performed based on the plurality of reference text chunks, authenticity and properness of a data pair can be greatly improved, thereby improving data quality of the retrieval library.

It can be known from the foregoing two aspects that paragraph segmentation processing may be performed on the knowledge document and the initial text chunk according to the text logical relationship. For ease of description, in this embodiment of this application, the knowledge document or the initial text chunk on which paragraph segmentation processing is performed is represented as text content. The text logical relationship of the text content is a logical relationship configured for representing an overall structure of the text content, and may include a general-to-specific relationship and a parallel relationship. The general-to-specific relationship indicates that a content structure of the text content is a general-to-specific structure. That is, the beginning of the text content is usually a paragraph that summarizes a full text, and paragraphs that come after the beginning of the text content are usually some explanation paragraphs for the paragraph that summarizes the full text. The parallel relationship indicates that the content structure of the text content is a parallel structure. That is, parts included in the text content are in a parallel logical relationship. Therefore, according to different text logical relationships of the text content, manners of paragraph segmentation processing on the text content are different. 1 When the text logical relationship of the text content is a general-to-specific relationship, the text splitter may segment the text content into a general text chunk and one or more specific text chunks according to the general-to-specific structure, that is, the text content is segmented into a general text chunk and one or more specific text chunks. The general text chunk is content that has a general effect in the text content, that is, some text content that has a summarization effect in the text content. The specific text chunk is content that has an explanation effect on the general text chunk in the text content. For example, a specific text chunk mainly describes a knowledge point under the general text chunk. 2 When the text logical relationship is a parallel relationship, the text splitter may segment the text content into at least two specific text chunks based on the parallel structure, that is, the text content is segmented into at least two specific text chunks. There is an independent relationship (or independence) between the at least two specific text chunks. The independent relationship herein is embodied in that content/opinions/facts expressed by the at least two specific text chunks are different, so that the independence between the specific text chunks can be clearly identified during subsequent analysis, thereby avoiding a topic and logic disorder.

The knowledge document is segmented from the dimension of the text logical relationship, to obtain a plurality of reference text chunks corresponding to the knowledge document, so that each reference text chunk obtained through segmentation has a logically clear feature. In this way, when subsequent data pair construction and retrieval library construction are performed based on the plurality of reference text chunks, authenticity and properness of a data pair can be greatly improved, thereby improving data quality of the retrieval library.

In conclusion, in embodiments of this application, a knowledge document is mainly segmented for a plurality of times from dimensions of topic consistency, a word count requirement, and a text logical relationship, to obtain a plurality of reference text chunks corresponding to the knowledge document. In this way, each reference text chunk obtained through segmentation has features such as that the reference text chunk has the same important knowledge point (for example, a single topic), a character quantity is less than the character quantity threshold, and logic is clear. s12: Perform semantic summarization on text semantics of each reference text chunk of the one or more reference text chunks, to obtain general information corresponding to each reference text chunk.

s13: Add the general information corresponding to each reference text chunk to a target position in the corresponding reference text chunk, to obtain a text chunk corresponding to each reference text chunk, the text chunk corresponding to each reference text chunk forming the text chunk set.

In operations s12 and s13, in the text segmentation processing provided in this embodiment of this application, not only the text content (such as the knowledge document or the initial text chunk) is segmented, but also small summarization rewritten content (referred to as general information in this embodiment of this application) is newly added to the corresponding reference text chunk based on the original text of the reference text chunk. The summarization rewritten content mainly describes a logical status of the reference text chunk in the entire document, so that information of each text chunk is sufficiently complete. An example in which the reference text chunk is the general text chunk and the specific text chunk mentioned in operation s11 is configured for describing the summarization rewritten content of the reference text chunk. The general information obtained by the text splitter by performing semantic summarization on the general text chunk is configured for indicating overall semantics expressed by text content corresponding to the general text chunk, so as to clearly identify generality of the general text chunk during subsequent analysis. Similarly, the general information obtained by the text splitter by performing semantic summarization on the specific text chunk is configured for indicating specific semantics and a logical structure expressed by the specific text chunk (that is, the specific text chunk has an explanation effect on the general text chunk) and overall semantics expressed by text content to which the specific text chunk belongs, so as to ensure information integrity of each finally segmented text chunk.

Based on the foregoing descriptions about the general information of the reference text chunk, the text splitter in this embodiment of this application performs semantic summarization on each of the plurality of reference text chunks corresponding to the knowledge document, to obtain a text chunk corresponding to each reference text chunk, thereby obtaining a text chunk set. The text chunk set includes a plurality of text chunks, each text chunk has one topic, and each text chunk includes one reference text chunk belonging to the knowledge document and corresponding general information (that is, the foregoing mentioned summarization rewritten content), and the general information is obtained by summarizing text semantics of the corresponding reference text chunk. In addition, this embodiment of this application supports adding the general information of the reference text chunk to a target position in the reference text chunk, to obtain a text chunk corresponding to the reference text chunk. The target position herein may include: a segment beginning, a segment middle, or a segment end of the reference text chunk. This is not limited.

The text splitter performing the text segmentation processing shown in the foregoing operations s11 to s13 may be a generative pre-trained model. It can be known from the foregoing related descriptions of the generative pre-trained model, namely, the GPT model, that the GPT model has an extremely strong full-text understanding capability and summarization capability, can adapt to a plurality of languages and document formats, and has a large amount of knowledge background at a bottom layer. In this embodiment of this application, the GPT model may be used as a semantic-level text splitter, to implement text segmentation processing on the knowledge document. In actual application, this embodiment of this application supports using the GPT model to implement the foregoing text segmentation processing process in a manner of prompt guidance and fine adjustment. \textcircled{1} The prompt may be referred to as a prompt word. In an AI large model, a function of the prompt is mainly to prompt, for the AI model (for example, the GPT model involved in this application), a context of input information and parameter information of an input model, so that the AI large model can implement a corresponding function in a case of prompt boot/reminding. In this embodiment of this application, the prompt is mainly configured for prompting the GPT model, so that the GPT model performs the foregoing process of text segmentation processing according to the prompt. \textcircled{2} Fine-tuning may refer to a process in which a GPT model is pre-trained by using training data, so that the GPT model has some particular capabilities. For example, in this embodiment of this application, the GPT model may be fine-tuned, so that the GPT model has a capability of performing semantic information extraction on the knowledge document.

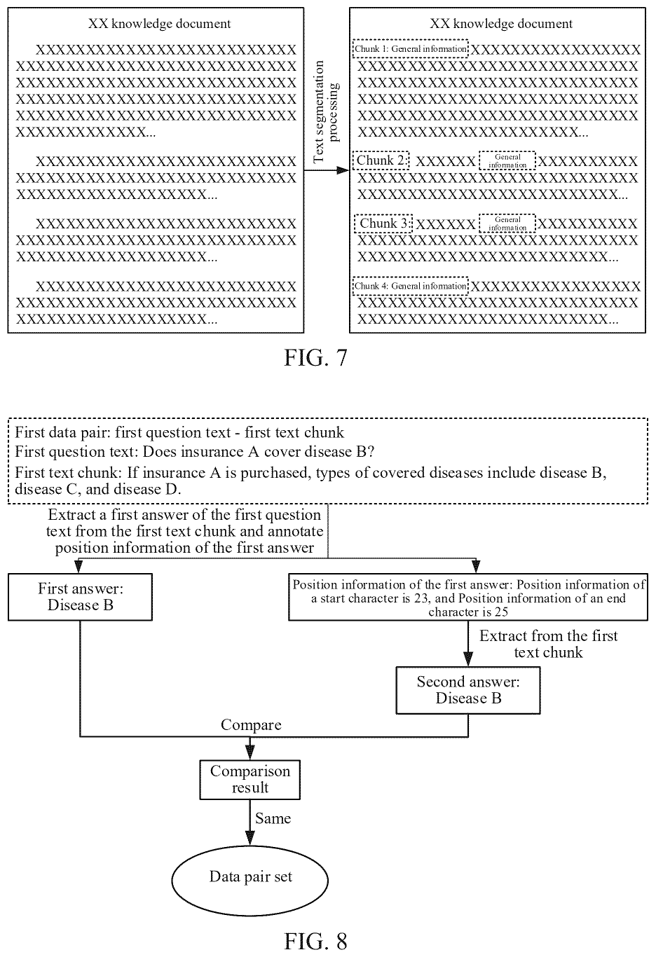

An example process of performing text segmentation processing on the knowledge document by using the GPT model is described below with reference to FIG. 7 and by using an example in which the text splitter is a GPT model. As shown in FIG. 7, assuming that the text logical relationship of the knowledge document is a general-to-specific relationship, according to processing logic of text segmentation processing shown in FIG. 6, an effect of segmenting the knowledge document by using a prompt-guided GPT model is as follows: Segmentation is performed by means of semantic understanding and the general-to-specific relationship, the first paragraph of the knowledge document is divided into the first text chunk. The first text chunk is a general text chunk, and corresponding general information thereof is configured for representing a logical structure (for example, a summarization part) and semantic information of the first text chunk in the knowledge document. Each paragraph following the first paragraph in the knowledge document is divided as one text chunk. Certainly, if topics of two adjacent paragraphs are the same and a quantity of characters is less than the character quantity threshold, the same text chunk may include at least two paragraphs. A quantity of paragraphs included in the text chunk is not limited in this embodiment of this application. In addition, each text chunk located after the first text chunk in the knowledge document has corresponding general information, configured for representing semantics of the corresponding text chunk and overall semantics of the entire knowledge document.

In FIG. 7, adding the general information to the reference text chunk to generate a corresponding text chunk is described by using an example in which the general information is added to a front position (for example, after first several characters of the reference text chunk) in the reference text chunk. In actual application, the general information may further be added to the beginning or the end of the reference text chunk, which is not limited.

Advantages of this embodiment of this application are described by using an example in which the text segmentation method provided in this embodiment of this application is compared with conventional text segmentation. The conventional text segmentation manner may include a LangChain algorithm, an NLTK algorithm, a spacy algorithm, and the like. In the conventional LangChain, a character list is used as a parameter, and all paragraphs are put together as much as possible, resulting in the same topic. For example, a summarization paragraph in a general-to-specific structure is divided into a plurality of chunks, resulting in excessively fine segmentation of text chunks, causing an information loss. A sentence segmentation method in the conventional NLTK algorithm is mainly based on a punctuation (such as a full stop, a question mark, and an exclamation mark) to segment a text into sentences. Consequently, a text with an original document having a complex structure and language feature cannot be segmented. A sentence segmentation method in the conventional spacy algorithm is mainly based on a rule and a statistical method. Word segmentation and sentence segmentation of a text are implemented by identifying a blank space, a punctuation, a dependency relationship, and a grammar rule of a particular language, and segmentation is implemented without reference to semantics of a document. Consequently, problems such as unclear logic and an information loss occur.

However, to ensure information integrity and continuity of each reference text chunk of the knowledge document, in this embodiment of this application, each reference text chunk is properly summarized by using the GPT model to obtain the general information, and the general information is added to the corresponding reference text chunk, so as to achieve brief explanation of the corresponding reference text chunk. In this way, each text chunk has complete information and has a proper knowledge density, and it is ensured that when a feature vector corresponding to the text chunk is placed in the retrieval library, the feature vector is presented as consecutive information, which is more beneficial to data management and retrieval of the retrieval library. That is, compared with some existing text segmentation manners in which segmentation is performed mainly depending on a document format (such as a line break, a quantity of markdowns, and a punctuation mark) or by using a conventional NLP method, this segmentation processing manner provided in this embodiment of this application can effectively overcome defects such as an information loss (for example, in a text segmentation process, because a meaning of a document is essentially not understood when the document is segmented by using a hard standard or a conventional algorithm, especially when a concept in a text spans a plurality of parts, some important information may be lost), a context relationship loss (for example, an original context relationship may be lost after a segmented text fragment, causing difficulty in understanding), and relatively strong language field dependency (for example, a conventional text segmentation method may be effective for a document in a particular language or field, but may have a poor effect in other cases, and for a document with a complex structure and format, segmentation may become more difficult). Therefore, the text chunk has the same important knowledge point and complete information, a clear topic, and clear logic, thereby greatly improving data quality of the retrieval library.

S502: Perform question writing on each text chunk based on the text chunk set and the general information included in each text chunk, to obtain one or more question texts corresponding to each text chunk; combine the one or more question texts corresponding to each text chunk with the corresponding text chunk separately, to obtain one or more data pairs corresponding to each text chunk; and generate a data pair set based on the one or more data pairs corresponding to each text chunk.

After the text chunk set obtained through segmentation of the knowledge document is obtained based on operation S501, in this embodiment of this application, question generation is performed on each text chunk in the text chunk set by using a key pair generator, so as to form a data pair by using the text chunk and the question text generated based on the text chunk, so that one or more data pairs corresponding to each text chunk form the data pair set. In this way, the data pair set may include a plurality of data pairs, each data pair includes one question text and one text chunk that are matched, the question text in each data pair is obtained by performing question writing on the text chunk matching the question text, and the text chunk in each data pair is used as an answer source of the question text matching the text chunk.

In this embodiment of this application, considering that a data format of input data of the retrieval model is a data pair, the operation of generating a data pair set based on the text chunk set is provided. In detail, considering that a conventional retrieval model such as a termfrequency_inversedocumentfrequency (TF-IDF) or best matching 25 (BM25) algorithm represents a question and a context as a sparse high-dimensional space vector by means of highly efficient matching of keywords, this manner is merely performing retrieval on word matching, does not consider correlation between semantics of text chunks, and has a relatively large limitation. The DPR model/algorithm provides a representation by using a space vector that is dense and can include semantic information. By optimizing a maximized inner product of feature vectors of a question text and a related text chunk, an objective is to compare similarity between feature vectors of a question text and a corresponding text chunk for all data pairs within a data pair set (i.e., a batch of data pairs). Each data pair can be represented as a question-passage pair or a key-value pair (abbreviated as k-v pair, where ‘k’ stands for key, which in embodiments of this application can represent the question text, and ‘v’ stands for value, which in embodiments of this application can represent a text chunk serving as an answer source of a matched question text). This seemingly straightforward method achieves high retrieval accuracy, for example, outperforming article retrieval accuracy of Lucene-BM25 by 9% to 19% in terms of top-20 article retrieval accuracy. Based on this, in this application, the DPR model is used as a retrieval model, to implement answer retrieval in an interactive dialog scenario, specifically, retrieval of a text chunk including an answer of a question. When employing the DPR algorithm as the retrieval model, the most crucial aspect is construction of a question-retrieved answer key-value pair (specifically, a text chunk containing a retrieved answer).

Further, in this embodiment of this application, a key pair generator is configured for generating a matching question text for each text chunk in the text chunk set, and generate, based on the text chunk and the question text matching the text chunk, a data pair corresponding to the text chunk, to obtain a data pair set. Considering that the GPT model has strong text comprehension and dialog interaction capabilities, this embodiment of this application supports using GPT as a key-pair generator to perform question generation on a text chunk through prompt guidance (related content of the prompt can be found in the preceding related descriptions, which are not repeated herein).

The process of using the GPT model to perform question writing on each text chunk based on the text chunk set and the general information included in each text chunk, to obtain one or more question texts corresponding to each text chunk; combine the one or more question texts corresponding to each text chunk with the corresponding text chunk separately, to obtain one or more data pairs corresponding to each text chunk; and generate a data pair set based on the one or more data pairs corresponding to each text chunk includes:

(1) The GPT model obtains scenario information corresponding to the interactive dialog scenario, where the scenario information includes a dialog style, an interaction manner, and an interaction field. For related content about the scenario information in the interactive dialog scenario, refer to related content in the foregoing embodiment in FIG. 4, and details are not described herein again. In addition, the GPT model determines, based on scenario information, a text chunk set, and general information included in each text chunk, a question style and a question quantity (or referred to as a quantity of questions) that match each text chunk.

Specifically, the GPT model mines a key element on each text chunk according to the text chunk set and the general information included in each text chunk, to obtain a key element of each text chunk. The key element of the text chunk herein refers to a factor that is crucial for the text chunk, that is, a factor that can represent a feature of the text chunk, and may include, but is not limited to, a keyword, a context relationship, a logical relationship, and the like. Then, the GPT model determines, based on the scenario information and the key element of each text chunk, the question style and the question quantity that match each text chunk. There is one or more question styles that match each text chunk. Each question style belongs to one of a plurality of dialog styles. The dialog style includes at least one of the following: a factual style, an explanatory style, a reasoning style, an evaluative style, and an assumption style. In addition, according to different interactive dialog scenarios, a weight value of a question quantity in each question style corresponding to a text chunk may be different. A larger weight value of the question quantity herein indicates a larger question quantity. Otherwise, a smaller weight value of the question quantity indicates a smaller question quantity. For example, in an interactive dialog scenario of insurance query, a question quantity of the explanatory style is greater than a question quantity of the reasoning style. In this manner, with reference to scenario information and content of a text chunk, a question style and a question quantity that adapt to the text chunk can be accurately matched, thereby implementing accurate question writing by using the question style and the question quantity. Further, key element mining is performed on the text chunk by using the general information, and then an obtained key element is configured for determining a question style and a question quantity that match the text chunk, so that when the question style and the question quantity that match the text chunk are determined, interference of redundant information can be excluded. In addition, by performing adaptation by using a smaller quantity of key elements, efficiency of determining the question style and the question quantity that match the text chunk can be effectively improved. (2) Question writing is performed on each text chunk according to the question style and the question quantity that match each text chunk, to obtain one or more question texts corresponding to each text chunk. In this embodiment of this application, processing such as semantic extraction on the text chunk is mainly implemented by using the GPT model, to generate the one or more question texts for the text chunk. That is, the operation of obtaining the one or more question texts corresponding to each text chunk in this embodiment of this application may be implemented by using the GPT model. For example, three question texts that are generated for the text chunk by using the GPT model may be as shown in Table 1 below:

Table 1 is described by using an example in which a product
is located as medical insurance, and does not limit a product
applicable to this embodiment of this application and a
generated question. Details are described herein.

| | Answer in a | Answer generated based |
|---|---|---|
| Question text | text chunk | on a text chunk |
| Purchase insurance, whether | Disease A | Yes, after the insurance is |
| it covers guarantee of | | purchased, guarantee of |
| disease A? | | disease A is included. |
| With disease A, is it useful | Disease A | Yes, purchasing the |
| to purchase the insurance? | | insurance can cover |
| | | guarantee of disease A. |
| Whether disease B is | Disease B | Yes, disease B is covered |
| covered by the insurance? | | by the insurance, and |
| | | belongs to guarantee |
| | | item 1. |

In addition, as can be known from the related descriptions for text segmentation in the foregoing embodiment shown in FIG. 4, some text chunks may have a question-answering structure, that is, such a text chunk may be used as a data pair. For ease of description, an example in which a text chunk set includes a candidate text chunk, the candidate text chunk is a text chunk whose format conforms to the question-answering structure, and the candidate text chunk includes a question part and an answer part is used. Therefore, for the candidate text chunk of such a question-answering structure, in this embodiment of this application, construction of a new data pair is supported by question generalization. This manner of constructing a data pair by means of question generalization helps to generate key-value pairs of a plurality of dialog styles and type variants to some extent, improves richness of the key-value pairs, and effectively reduces workload compared with generating a question text by using a model. Specifically, when it is detected that the text chunk set includes a candidate text chunk, the candidate text chunk may be added to the data pair set, question generalization processing is performed on a question part included in the candidate text chunk, to generate a generalized question text, the generalized question text and the answer part included in the candidate text chunk are configured for forming a new data pair corresponding to the candidate text chunk, and the new data pair is added to the data pair set.

The foregoing question generalization processing manner not only may be applied to a candidate text chunk that is in the text chunk set and that has the question-answering structure, but also may be applied to an iteration stage of the DPR model. Specifically, a recall-failed data pair is configured for few-shot guidance of a question, thereby achieving question generalization for these few shots. The new data pair after question generalization is then added to a training set. This helps leverage a failure case to gradually enhance a vector expression capability of the DPR model, thereby improving model retrieval accuracy.

(3) One or more question texts corresponding to each text chunk are combined with the corresponding text chunk separately, to obtain one or more data pairs corresponding to each text chunk, and generate the data pair set based on the one or more data pairs corresponding to each text chunk.

To avoid as much as possible that the GPT model generates a hallucination in the process of generating the question text based on the text chunk, that is, the question text generated based on the text chunk is false, this embodiment of this application mandates that the answer corresponding to the generated question text necessarily comes from the corresponding text chunk, and position information of the answer of the question text can be positioned in the corresponding text chunk, thereby further improving pertinence and availability of the question. Therefore, after the key pair generator generates sufficient data pairs through the foregoing descriptions, this embodiment of this application further supports performing key pair verification on each data pair by using a key pair verifier, and only a data pair meeting a verification requirement can be added to the data pair set, to ensure that an answer of a question text included in a data pair in the data pair set can be extracted from a corresponding text, that is, determine that the data pair in the data pair set is training data that can be configured for subsequent training and verification. In this embodiment of this application, the GPT model is supported to be used as a key pair verifier, to implement key pair verification on a data pair corresponding to each text chunk, and secondary verification is performed on the data pair by using a strong text understanding capability of the GPT model, to ensure availability of the data pair and ensure properness of question generation.

For example, assuming that any text chunk in the text chunk set is represented as a first text chunk, any data pair corresponding to the first text chunk is represented as a first data pair, and the first data pair includes a first question text matching the first text chunk, for a specific process of performing secondary verification on the data pair by using the GPT model, to generate the data pair set, refer to FIG. 8. As shown in FIG. 8, first, the first answer that matches the first question text is extracted from the first text chunk based on the first question text by using a key pair verification model (that is, the key pair verifier mentioned above, and the key pair verifier may be the GPT model in this embodiment of this application), and position information of the first answer in the first text chunk is marked. The position information of the first answer in the first text chunk may be generated based on positions of a start character and an end character that form the first answer in the first text chunk. For example, when characters included in the first text chunk are marked in an order from left to right, position information of a start character “B” of a first answer “disease B” shown in FIG. 8 in the first text chunk is 23, and position information of an end character “disease” in the first text chunk is 25.

Then, according to the position information of the first answer in the first text chunk, a second answer indicated by the position information is extracted from the first text chunk. For example, according to the position information 23 and the position information 25, a second answer “disease B” is extracted from the first text chunk. Second, the first answer is compared with the second answer extracted based on the position information, to obtain a comparison result. The comparison between the first answer and the second answer herein may include but is not limited to: determining whether a character string including characters in the first answer and a character string including characters in the second answer are completely the same; and keywords are separately extracted from the first answer and the second answer by using a keyword extraction technology (for example, the Ner technology), and whether keywords of the first answer and the second answer match are compared (that is, are the same).

Finally, the first data pair is added to the data pair set according to the comparison result. If the comparison result indicates that the first answer is the same as the second answer, the first answer of the first question text in the first data pair may be extracted from the first text chunk in the first data pair, and the first data pair is added to the data pair set. On the contrary, if the comparison result indicates that the first answer is different from the second answer, the first answer of the first question text in the first data pair cannot be extracted from the first text chunk in the first data pair, the first data pair is not added to the data pair set, that is, the first data pair is a hallucination of the GPT model. In this case, the first data pair is discarded.

It can be seen that, in this embodiment of this application, a logic and a rule of question generation are set by determining the prompt, and question writing is performed on a text chunk without a question text by using the GPT model for the first time. Compared with a conventional method for extracting a question-answer record from historical data (for example, a common customer service question-answer manual, where answers are used as a retrieval library, and user questions are used as corresponding questions to form key-value pairs) or writing a question manually according to a text chunk, this greatly improves question production, and saves time and resources for question generation. In addition, to avoid as much as possible that the GPT model encounters a hallucination problem in a process of generating the question text for the text chunk, in this embodiment of this application, a key pair verifier is further constructed to perform secondary verification on the generated data pair, and only a successfully verified data pair (that is, the text chunk in the data pair is indeed an answer source of the corresponding question text) can be added to the data pair set, so that availability and data quality of the key pair can be effectively ensured, thereby improving model performance of the second retrieval model obtained through training by using the data pair set and data quality of the retrieval library.

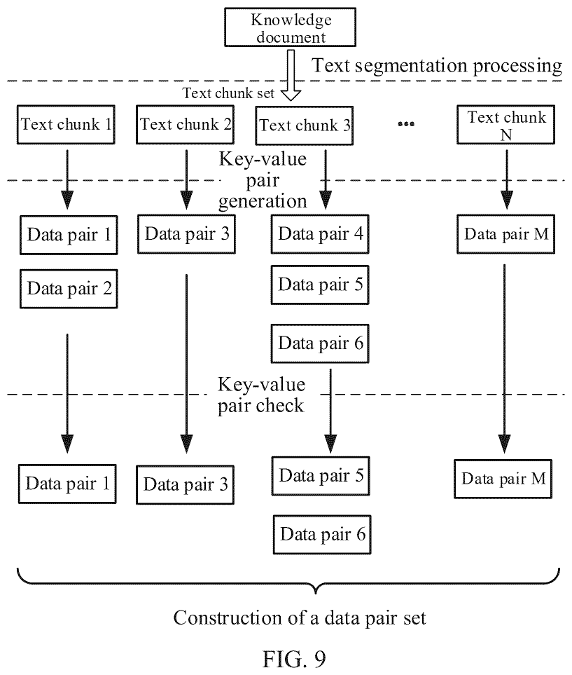

For ease of understanding the specific process shown in operations S501 and S502, the following provides a complete procedure of text segmentation processing, key-value pair generation, and key-value pair verification again with reference to FIG. 9. As shown in FIG. 9, first, after receiving a knowledge document, a text splitter may perform text segmentation processing on the knowledge document, to obtain one or more text chunks. The text chunks form a text chunk set. Then, question generation is performed on each text chunk in the text set by using a key pair generator, to obtain one or more data pairs corresponding to each text chunk. In addition, if the text chunk itself has a question-answering structure, question generalization is directly performed on a question part of the text chunk to generate a data pair. Finally, a key pair verifier is configured for performing secondary verification on the data pair corresponding to each text chunk, and data pairs that do not have a hallucination of the key pair generator are reserved to form a data pair set. In the foregoing procedure, the text splitter, the key pair generator, and the key pair verifier may each be a GPT model, but in a process in which the intelligent question-answering system executes each foregoing procedure, for different procedures and functions, data fine tuning and prompt adjustment may be performed on the GPT. Functions of each stage are completed by using the GPT model, thereby greatly reducing calculation and storage costs, significantly improving model accuracy, and widening a capability boundary of the AI system (that is, the intelligent question-answering system).

S503: Train a first retrieval model by using the data pair set, to obtain a second retrieval model.

Training data for retrieval model training usually includes a training set for retrieval model training and a verification set for retrieval model testing/verification. Therefore, after the data pair set is constructed based on the foregoing operations, data allocation processing (that is, text allocation processing) needs to be performed on the data pair set by using a text allocator, so as to extract some data pairs from the data pair set as a verification set of the first retrieval model, and remaining data pairs other than the extracted data pairs in the data pair set are used as a training set of the first retrieval model, thereby training the first retrieval model based on the training set and the verification set, to obtain a trained first retrieval model (that is, the second retrieval model). Data allocation processing is first performed to obtain a training set and a verification set, and the first retrieval model is trained by first training and then testing, so that a model error can be identified and corrected in a training process, thereby improving accuracy of the model. In addition, an independent testing set is configured for evaluating a generalization capability of the model at a testing stage, to ensure that the model does not rely on training data, thereby detecting and reducing an overfitting phenomenon.

During specific implementation: (1) The text allocator may perform data allocation processing on the data pair set according to a data allocation policy, to obtain a first data pair set and a second data pair set. When the first data pair set herein is the verification set, the second data pair set is the training set complementary to the first data pair set. Otherwise, when the first data pair set is the training set, the second data pair set is the verification set complementary to the first data pair set. Types of the first data pair set and the second data pair set are not limited in this embodiment of this application.

The data allocation policy in the foregoing description may include: an answer layering policy and a word embedding classification policy. \textcircled{1} The answer layering policy is mainly to layer a text chunk by using a position of an answer in the text chunk as a reference, and extract a data pair at a particular ratio from each layer to form a data pair set. Specifically, as can be known from the foregoing description, answers corresponding to question texts in a plurality of data pairs generated by using the same text chunk may be at different positions in the text chunk, then the text chunk may be layered according to position information (including a starting position and an ending position) of the different answers in the text chunk, then a proportion of data pairs corresponding to the question text is randomly extracted from each layer as the first data pair set, and a data pair that is not extracted from each layer is used as the second data pair set. In this way, it can be ensured that an answer knowledge point related to a question text in a data pair set (such as the first data pair set or the second data pair set) is similar to an entire question set, thereby improving comprehensiveness of data set pairs. \textcircled{2} The word embedding classification policy is mainly to extract a proportion of data pairs to form a data pair set in a manner of clustering word vectors of question texts in the data pair. Specifically, according to an expression form of a word (or a character or a character string), a word embedding technology may be used. The word embedding is configured for representing a word or a phrase as a vector of a fixed size, and these vectors can capture features such as similarity between words and a context relationship. First, each character in the character string that forms the question text is converted into a vector by using a word embedding method (such as Word2Vec, GloVe, FastText, or BERT), and vectors of the characters are clustered (such as k-means clustering or hierarchical clustering processing). A clustering result is used as a division basis, to divide character strings having similar representation forms into the same group, so as to extract from these groups. In this way, representation forms of different questions are kept to the greatest extent, and diversity and balance of data pairs are increased.

Specific implementations of the foregoing two data allocation policies are described in detail below by using an example in which any text chunk in the text chunk set is represented as a first text chunk, the first text chunk is corresponding to Q first data pairs, Q is an integer greater than 0, and a question text in the first data pair is formed by one or more characters.

In an implementation, the data allocation policy is an answer layering policy. In this implementation, the text allocator may determine position information, in the first text chunk, of the answer corresponding to the question text in each first data pair of the Q first data pairs corresponding to the first text chunk. Then, layered processing is performed on the first text chunk according to the position information that is of the answer corresponding to the question text in each first data pair and that is in the first text chunk, to obtain a plurality of text sublayers corresponding to the first text chunk, one text sublayer being corresponding to at least one first data pair of the Q first data pairs. Finally, a reference data pair is selected from the first data pair corresponding to each text sublayer of the plurality of text sublayers and the reference data pair is added to the first data pair set, and a first data pair other than the selected reference data pair in the plurality of text sublayers is added to the second data pair set. It can be seen that, when a target set (such as the first data pair set or the second data pair set) is constructed by using the answer layering policy, it can be ensured that the first data pair in the target set comes from different layers in the first text chunk, thereby ensuring that answer knowledge points related to the question text in the target set are located at various layers of the first text chunk, and further improving that the answer knowledge points related to the question text in the target set are similar to the entire question set.

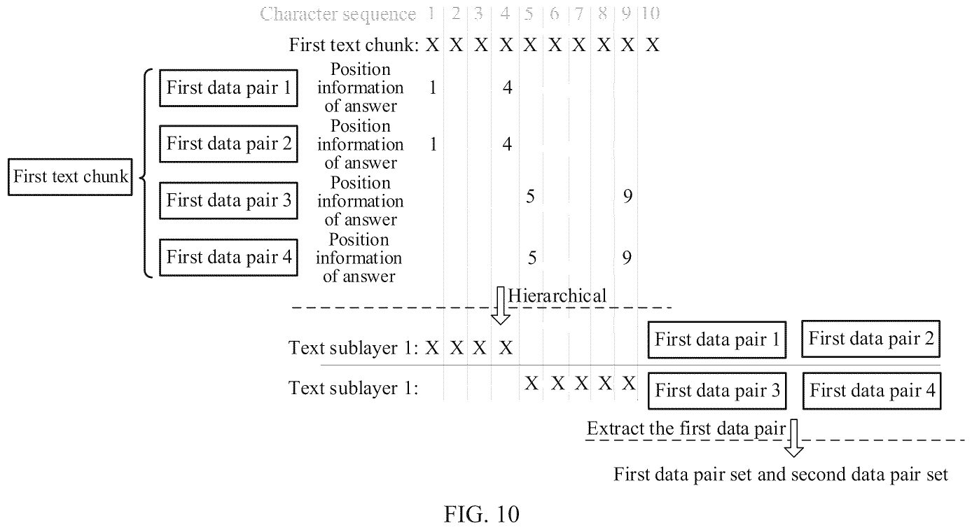

As shown in FIG. 10, it is assumed that a first text chunk includes 10 characters in total, and the first text chunk is corresponding to four first data pairs (that is, Q=4), which are respectively a first data pair 1, a first data pair 2, a first data pair 3, and a first data pair 4. The position information, in the first text chunk, of the answer corresponding to the question text in each first data pair of the four first data pairs may be represented as: position information, in the first text chunk, of an answer of a question text in the first data pair 1 is a starting position 1 (1 is an order of the first character of the answer in the first text chunk) and an ending position 4 (4 is an order of the last character of the answer in the first text chunk); position information of an answer of a question text in the first data pair 2 in the first text chunk is the starting position 1 and the end position 4, position information of an answer of a question text in the first data pair 3 in the first text chunk is a starting position 5 and an end position 9, and position information of an answer of a question text in the first data pair 4 in the first text chunk is the starting position 5 and the end position 9. Further, the first text chunk is layered according to the position information that is of the answer corresponding to the question text in the four first data pairs and that is in the first text chunk, to roughly obtain two text sublayers. Position information of a text sublayer 1 is the starting position 1 and the ending position 4, and the text sublayer 1 is corresponding to the first data pair 1 and the first data pair 2. Similarly, position information of a text sublayer 2 is the starting position 5 and the ending position 9, and the text sublayer 2 is corresponding to the first data pair 3 and the first data pair 4. Further, a proportion (for example, 50%) of first data pairs may be extracted from the first data pair 1 and the first data pair 2 corresponding to the text sublayer 1 and added to the first data pair set, and a first data pair that is not extracted in the text sublayer 1 is added to the second data pair set. Similarly, a proportion (for example, 100%) of first data pairs may be extracted from the first data pair 3 and the first data pair 4 corresponding to the text sublayer 2 and added to the first data pair set, and a first data pair that is not extracted in the text sublayer 2 is added to the second data pair set.

In another implementation, the data allocation policy is a word embedding classification policy. In this implementation, the text allocator may separately perform word vector representation on Q question texts in the Q first data pairs corresponding to the first text chunk, to obtain a word vector corresponding to each question text of the Q question texts. A vector distance between word vectors corresponding to different question texts is configured for indicating similarity between the different question texts. Specifically, a shorter vector distance between at least two word vectors indicates higher similarity between the at least two question texts corresponding to the at least two word vectors, and indicates that questions that the at least two question texts want to query may be closer to or the same. Then, the word vectors corresponding to the Q question texts are clustered, to obtain one or more cluster groups. One cluster group includes first data pairs corresponding to one or more question texts whose vector distances meet a distance requirement. The vector distance meeting the distance requirement herein may mean that the vector distance is less than a distance threshold. In other words, it is supported to divide a first data pair corresponding to a question text corresponding to a word vector whose vector distance is less than the distance threshold into one cluster group, so that question texts included in a first data pair in each cluster group are similar. Finally, a reference data pair is selected from the one or more cluster groups and added to the first data pair set, and a first data pair other than the selected reference data pair in the one or more cluster groups is added to the second data pair set. It can be seen that, when the same cluster group includes a plurality of similar first data pairs, first data pairs are extracted from different cluster groups to form a target set, so that representation forms of different questions can be kept to a large extent, and diversity and balance of target sets can be increased. The vector distance may be specifically a Euclidean distance, a Manhattan distance, a Hamming distance, or the like. The distance threshold may be configured according to an actual application scenario, and may be specifically a preset value threshold.

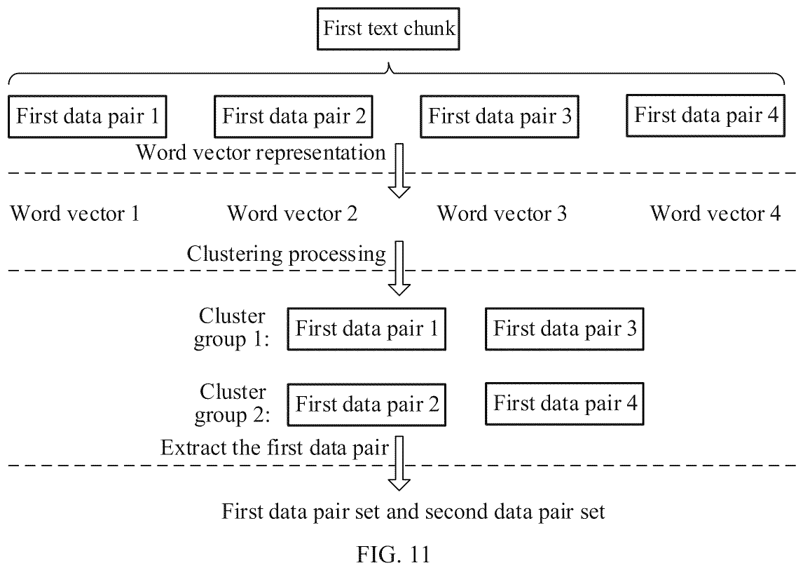

As shown in FIG. 11, it is assumed that a first text chunk includes 10 characters in total, and the first text chunk is corresponding to four first data pairs (that is, Q=4), which are respectively a first data pair 1, a first data pair 2, a first data pair 3, and a first data pair 4. Then, after word vector representation is performed on question texts in the four first data pairs, to obtain word vectors corresponding to the four question texts, the word vectors corresponding to the four question texts may be clustered, to obtain one or more cluster groups. Assuming that a vector distance between a word vector of a question text in the first data pair 1 and a word vector of a question text in the first data pair 3 is less than a distance threshold, it is determined that the first data pair 1 and the first data pair 3 are divided into the same cluster group (for example, a cluster group 1). Similarly, assuming that a vector distance between a word vector of a question text in the first data pair 2 and a word vector of a question text in the first data pair 4 is less than a distance threshold, it is determined that the first data pair 2 and the first data pair 4 are divided into the same cluster group (for example, a cluster group 2). In this way, a proportion of first data pairs may be separately extracted from the cluster group 1 and the cluster group 2 and added to the first data pair set, and remaining first data pairs that are not extracted are added to the second data pair set.

In FIG. 10 and FIG. 11, a single text chunk is used as an example to describe a text allocation process of one or more data pairs corresponding to the single text chunk in the data pair set. However, in actual application, a text allocation manner of a data pair corresponding to each text chunk in the data pair set is the same as the foregoing processes shown in FIG. 10 and FIG. 11, and details are not described herein again.

(2) The first retrieval model is trained by using the training set, to obtain the trained first retrieval model. A process of training the first retrieval model by using the training set may include a plurality of rounds of iterative training, and the first retrieval model after the last round of iterative training is used as a second retrieval model having better model prediction performance. During subsequent model application, the second retrieval model is configured for implementing question retrieval.

When the first retrieval model may be a two-tower model, such as a DPR model, any round of iterative training process for the DPR model may include: using the data pair included in the training set as input data of the DPR model. In this case, according to a two-tower model structure of the DPR model (that is, including a submodel 1 for vector expression about a question and a submodel 2 for vector expression about a text chunk), vector embedding processing may be performed on the question text in the data pair by using the submodel 1 in the DPR model, to obtain a feature vector of the question text. In addition, vector embedding processing is further performed on the text chunk in the data pair by using the submodel 2 in the DPR model, to obtain a feature vector of the text chunk. Then, retrieval model training is configured for making a feature difference between the question text and the text chunk that are matched in each data pair be less than a preset threshold, that is, a model parameter of the DPR model is optimized according to a direction of reducing a difference between the feature vector of the question text and the feature vector of the text chunk in the same data pair, and the foregoing optimization process is repeated, until the DPR model has a good vector expression capability for the question text and the text chunk. Specifically, vector expressions of the question text and the text chunk that are embodied in the same data pair are similar.

(3) The trained first retrieval model is tested by using the verification set, to obtain the second retrieval model. After the second retrieval model is obtained through the foregoing retrieval model training process, the second retrieval model corresponds to the retrieval library. The retrieval library includes the feature vector obtained by performing vector embedding processing on each text chunk in the text chunk set by the second retrieval model. In this way, the second retrieval model and the retrieval library may be used together for generating, in the interactive dialog scenario, the first answer of the first question text inputted by the object. A manner of constructing the retrieval library corresponding to the second retrieval model may include: In some embodiments, the feature vector of the text chunk included in the retrieval library is obtained in a retrieval model training process. Specifically, considering that when the first retrieval model is trained for the last time, the first retrieval model has a better vector representation for a text chunk included in a data pair in the training set. Therefore, this embodiment of this application supports adding the feature vector for the text chunk included in each data pair in the training set to the retrieval library in the last round of iterative training, to construct the retrieval library. The same text chunk is usually corresponding to a plurality of data pairs. Therefore, before the feature vector of the text chunk included in each data pair in the training set is added to the retrieval library, deduplication processing further needs to be performed on the feature vector of the text chunk included in each data pair. Specifically, if different data pairs include the same text chunk, a feature vector of a text chunk included in one data pair is selected to be added to the retrieval library. In some embodiments, the feature vector of the text chunk in the retrieval library may alternatively be obtained by performing vector embedding processing on the text chunk in the text chunk set by using the second retrieval model. That is, considering that each text chunk in the text chunk set is independent and unique, after the second retrieval model is obtained, vector embedding processing may be directly performed on the text chunks in the text chunk set by using the second retrieval model, to obtain the feature vector, without performing a deduplication operation.

In conclusion, on the one hand, in the embodiments of this application, it is ensured that a text chunk has a single topic and general information during text segmentation, thereby ensuring good quality of the text chunk. On the other hand, a matching question is generated directly based on a text chunk to construct a data pair, thereby effectively improving authenticity and data quality of the data pair. Furthermore, when the retrieval model is trained based on the data pair with relatively good quality, the retrieval model is trained in a direction that ensures that a feature difference of the same data pair decreases, so that the retrieval model has a relatively good feature representation capability for both the question text and the text chunk, thereby obtaining a second retrieval model with a relatively good vector expression capability and a retrieval library with relatively good data quality.

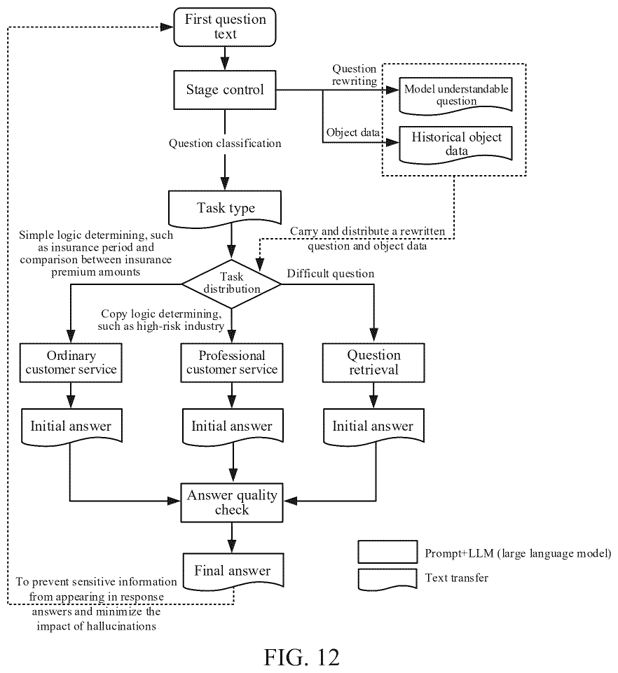

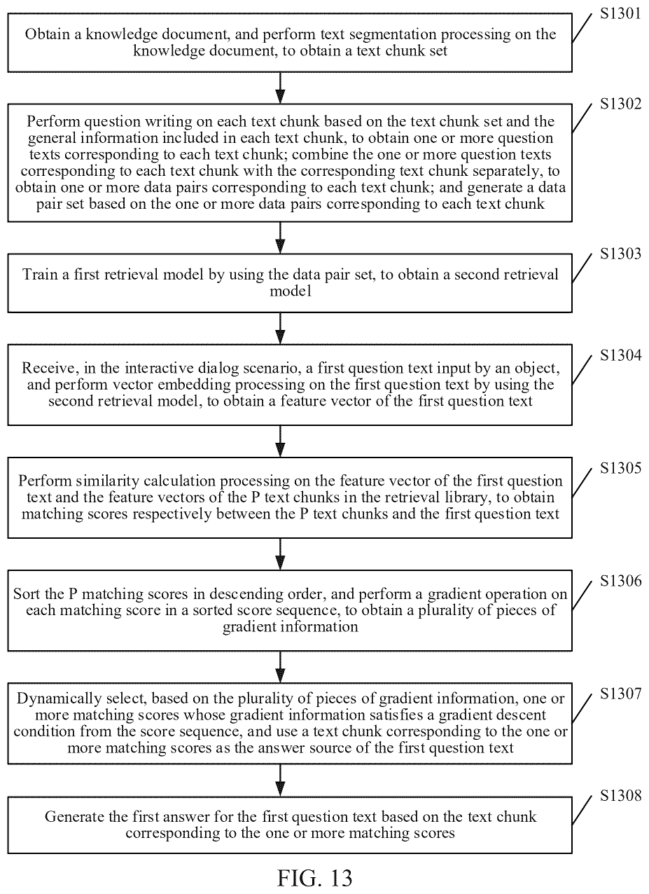

The foregoing embodiments shown in FIG. 4 and FIG. 5 mainly describe data pair construction, retrieval model training, and retrieval library construction. Specific content of a model application is described below with reference to embodiments shown in FIG. 12 and FIG. 13. As shown in FIG. 12, in a model application process, after receiving a first question text of an object, an intelligent question-answering system may perform vector embedding processing on the first question text by using a second retrieval model, to obtain a feature vector of the first question text, and perform similarity calculation on the feature vector of the first question text and a feature vector of a text chunk included in a retrieval library, to determine one or more text chunks matching the first question text. At a retrieval filtering stage, in addition to the similarity calculation manner described above, another matching manner may also be used, for example, extracting key information in the first question text and performing keyword matching on the retrieval library, so as to determine uniqueness of a keyword and necessity of recalling a text chunk by using a quantity of matched keywords.

Then, the intelligent question-answering system performs task classification on the first question text, to determine a difficulty level of the first question text. In addition to performing task classification according to the question difficulty, the first question text may also be classified according to another dimension, for example, according to an urgent degree of a task or a text topic of the first question text. Finally, the one or more text chunks matching the first question text are sent to a corresponding answer model according to the difficulty level of the first question text, so as to generate a corresponding first answer for the first question text based on the one or more text chunks. For example, an answer generation model corresponding to a common customer service, an answer generation model corresponding to a professional customer service, and an answer generation model corresponding to question retrieval may correspond to different GPT models. The common customer service and the professional customer service are mainly configured for making yes/no judgments based on user information or for simple judgments with known core instructions. A specific question (for example, guarantee details of an insurance product) or a difficult question may be answered by using question retrieval. As can be seen, in consideration of performance and memory reasons of a single GPT model, an extremely complex intelligent question-answering system cannot be borne. Therefore, this embodiment of this application supports using a plurality of GPTs to perform different role play and function implementation (for example, different GPT models (such as a common customer service and a professional customer service) that process questions of different difficulty levels, for another example, a GPT model that implements text segmentation, a GPT model that implements key pair generation, and a GPT model that implements key pair verification), to complete the entire intelligent AI question-answering system.

In addition, as described above, the intelligent question-answering system provided in this embodiment of this application further supports a plurality of rounds of question-answering. Specifically, customized replies to the same object are implemented with reference to historical object data of the object in a plurality of rounds of interactive dialogs. In a model application process, after obtaining the first question text, the intelligent question-answering system may rewrite the first question text based on historical object data of the object, so that a rewritten question text better matches the object data of the object, thereby better providing a personalized and customized first answer to the object.

Based on the foregoing general introduction of the model application in FIG. 12, the following introduces retrieval model training and a complete implementation process of the model application in detail with reference to FIG. 13. FIG. 13 is a schematic flowchart of a model method according to an exemplary embodiment of this application. A procedure of the retrieval model training method shown in FIG. 13 is mainly a procedure of model application of a second retrieval model. The retrieval model training method may be performed by a computer device, and specifically, is performed by an intelligent question-answering system installed in the computer device. The retrieval model training method may include but is not limited to operations S1301 to S1308:

S1301: Obtain a knowledge document, and perform text segmentation processing on the knowledge document, to obtain a text chunk set.

S1302: Perform question writing on each text chunk based on the text chunk set and the general information included in each text chunk, to obtain one or more question texts corresponding to each text chunk; combine the one or more question texts corresponding to each text chunk with the corresponding text chunk separately, to obtain one or more data pairs corresponding to each text chunk; and generate a data pair set based on the one or more data pairs corresponding to each text chunk.

S1303: Train a first retrieval model by using the data pair set, to obtain a second retrieval model.

For a specific implementation process shown in operations S1301 to S1303, refer to related descriptions of the specific implementation process shown in operations S501 to S503 in the embodiment shown in FIG. 5, and details are not described herein again.

Further, in a conventional retrieval solution, processing manners and application positions of all data are the same. However, in fact, data from different data sources has different information reliability and application universality, and to ensure information granularity, long files belonging to the same topic are segmented, so that a plurality of segmented text chunks originate from the same segment of words, that is, topics of the plurality of text chunks may be the same, but meanings and correlations thereof may be different. To fully use these differences of different text chunks in the retrieval library, in this embodiment of this application, after text segmentation processing is performed on the knowledge document, to obtain a text chunk set, a new index design is further set for each text chunk in the text chunk set, so that a specified text chunk can be searched (for example, according to a source or a topic) based on metadata, and management of the retrieval library (for example, updating, adding, or deleting a feature vector of a text chunk in the retrieval library) is facilitated according to the metadata.

During specific implementation, after the text chunk set is obtained, metadata extraction may be performed on each text chunk in the text chunk set, to obtain metadata of each text chunk. The metadata of any text chunk may be configured for describing a data property of the text chunk. The data property may include at least: a retrieval field to which the text chunk belongs, a source of the text chunk, a topic to which the text chunk belongs, and the like. That is, in an index design mechanism set in this embodiment of this application, three concepts are introduced to a text chunk, which are respectively: a retrieval field (or “field” for short), a source, and a topic. \textcircled{1} “Field” is an overall scope of a retrieval library during retrieval. For example, when the retrieval library includes feature vectors of text chunks of a plurality of insurance products, each insurance product may be a “field”, and in a retrieval model training process, it is feasible to perform retrieval model training of the first retrieval model by using data pairs in a plurality of fields. \textcircled{2} “Source” may be source information or a source position of the text chunk. For example, the source of the text chunk may be a question summary obtained in a customer service question-answering process. For another example, the source of the text chunk may be information obtained from an insurance clause. \textcircled{3} “Topic” is main knowledge content of the text chunk, and correlation between the text chunk and the question may be confirmed by using the topic.

In this embodiment of this application, updating of the retrieval library and index retrieval for the text chunk are supported by using metadata of each text chunk. \textcircled{1} The updating of the retrieval library may include: when a data property of a text chunk in the retrieval library is updated, modifying a property value of the corresponding data property in metadata of the text chunk, so as to update the text chunk. For example, when the retrieval library is continuously updated, a new version number or a version time (that is, a version update time) of a text chunk may be added to a data property “source” of the text chunk, so that the retrieval library is manageable, may be increased or decreased, and may be replaceable. \textcircled{2} Index retrieval for the text chunk includes at least: 1. retrieving, from metadata according to a retrieval requirement indicated by the first question text in the interactive dialog scenario, a text chunk whose metadata meets the retrieval requirement, to generate an answer for the first question text. For example, during a model application process, if the object specifies querying for an insurance product, the intelligent question-answering system can only retrieve a text chunk in the insurance product, rather than retrieve a text chunk in another insurance product. In this case, a text chunk meeting the specified insurance product needs to be selected according to a data property “field” as a text chunk matching the first question text of the object. 2. Retrieve, from the metadata when any text chunk has been retrieved in the interactive dialog scenario, a text chunk whose metadata is the same as metadata of the any text chunk, to generate an answer for the first question text. For example, as can be known based on related content of the foregoing text segmentation processing, for a long text belonging to the same topic, the same topic is configured for a plurality of text chunks obtained after the long text is segmented. Therefore, in a model application process, if one text chunk belonging to the same topic is recalled, another text chunk belonging to the same topic may be found according to a data property “topic”, and used as auxiliary information for retrieval (for example, as a retrieved text chunk to assist in generating an answer).

In an actual process of implementing index retrieval and retrieval library update by using metadata, considering that a data property “field” and a data property “source” are strongly related to a retrieval service and are explicit information (that is, directly identified as a text chunk, or added to a text chunk), the data property “field” and the data property “source” may be directly used. If the data property “topic” exists in a text chunk (for example, a title of the text chunk), the data property “topic” may also be directly used. However, if the data property “topic” does not exist in a text chunk, that is, the data property “topic” is implicit information, topic summarization may be performed in real time by using the foregoing GPT model.

In conclusion, in embodiments of this application, the foregoing described index mechanism is constructed for the text chunk in the retrieval library, so that index retrieval of the text chunk and updating of the retrieval library can be implemented by using a metadata structure, thereby making the retrieval library clearer, improving a retrieval speed and efficiency in a retrieval process, and facilitating management of the retrieval library.

S1304: Receive, in the interactive dialog scenario, a first question text inputted by an object, and perform vector embedding processing on the first question text by using the second retrieval model, to obtain a feature vector of the first question text.

As described above, the second retrieval model involved in this embodiment of this application may be a two-tower model. For example, the DPR model includes a submodel configured for performing vector expression on a question and a submodel configured for performing vector expression on a text chunk. Therefore, in an interactive dialog scenario of a model application, after receiving the first question text inputted by the object, the intelligent question-answering system may perform vector embedding processing on the first question text by using the submodel that is in the second retrieval model and that is configured for performing vector expression on the question, to obtain a feature vector of the first question text. The feature vector is configured for representing semantic information of the first question text.

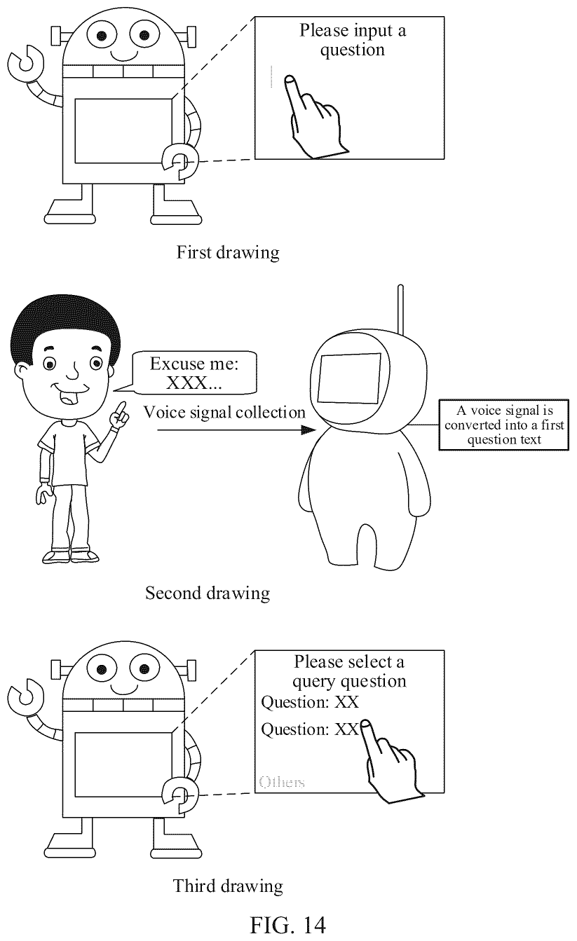

An interaction manner between the intelligent question-answering system and the object is not limited in this embodiment of this application, that is, a manner in which the intelligent question-answering system receives the first question text of the object is not limited. For example, in a first drawing shown in FIG. 14, the object may directly input the first question text in a text manner on a display screen of the intelligent question-answering system. In a second drawing shown in FIG. 14, the object may ask a question in a voice manner. In this case, the intelligent question-answering system may collect a voice signal of the object, and convert the voice signal into a first question text in a text form. In a third drawing shown in FIG. 14, the intelligent question-answering system may further actively output one or more candidate questions in a semantic or text form. In this way, the object selects a candidate question from the one or more candidate questions displayed on the display screen of the intelligent question-answering system as a to-be-queried first question text.

S1305: Perform similarity calculation processing on the feature vector of the first question text and the feature vectors of the P text chunks in the retrieval library, to obtain matching scores respectively between the P text chunks and the first question text.

S1306: Sort the P matching scores in descending order, and perform a gradient operation on each matching score in a sorted score sequence, to obtain a plurality of pieces of gradient information.

S1307: Dynamically select, based on the plurality of pieces of gradient information, one or more matching scores whose gradient information meets a gradient descent condition from the score sequence, and use a text chunk corresponding to the one or more matching scores as the answer source of the first question text.

In operations S1305 to S1307, it is considered that in this embodiment of this application, a target of training the second retrieval model is to make a feature difference between a question text and a text chunk that belong to the same data pair be relatively small, that is, a feature vector of the question text and a feature vector of the text chunk that belong to the same data pair are relatively similar, thereby ensuring that a corresponding answer can be definitely found in the text chunk for the question text that belongs to the same data pair. Therefore, the intelligent question-answering system in this embodiment of this application receives and invokes the second retrieval model to perform vector embedding processing on the first question text, to obtain the feature vector of the first question text, and may map the feature vector of the first question text to the retrieval library. Specifically, similarity calculation processing is performed on the feature vector of the first question text and the feature vector of each text chunk of the P text chunks in the retrieval library, to obtain matching scores respectively between the P text chunks and the first question text. The matching score corresponding to each text chunk is configured for indicating a credibility that the corresponding text chunk is used as an answer source of the first question text, or configured for indicating similarity between a feature vector of the corresponding text chunk and the feature vector of the first question text. In this way, a higher matching score corresponding to the text chunk indicates a higher possibility that the text chunk is used as an answer source of the first question text.

Considering that a common retrieval manner in the industry is extracting a specified quantity of text chunks from the retrieval library and delivering the text chunks to the intelligent question-answering system for answering, However, in fact, directly recalling a specified quantity of text chunks may cause too much invalid information in the recalled text chunks due to a reason that the quantity is specified. Consequently, answers are too tedious or even contradictory. To improve recall flexibility of a quantity of text chunks, an embodiment of this application designs a manner of dynamically recalling a text chunk based on a matching score (or referred to as a novel split-score dynamic selection form), to ensure that all recalled text chunks surround the first question text as much as possible and are concise and clear, thereby improving effectiveness and accuracy of the first answer generated for the first question text, to further improve retrieval precision.

A general principle of a manner of dynamically adjusting a recalled quantity of text chunks according to a matching score may include: for the first question text raised by the object, after matching scores between the first question text and P text chunks in the retrieval library are calculated by using the foregoing descriptions, the P matching scores may be ranked in descending order, to obtain a score sequence. The score sequence includes P matching scores with descending values. Then, descending gradients are calculated one by one for the score sequence. Specifically, a former matching score is subtracted from a latter matching score in two adjacent matching scores in the score sequence, to obtain P−1 pieces of gradient information, and normal fitting is performed on the gradient information and one or more significant descending gradients outside of [mean−3*standard deviation, mean+3*standard deviation] are found. These significant descending gradients indicate a significant decrease in the similarity between answers and questions. Then, a matching score (that is, one or more matching scores that meet a gradient descent condition) corresponding to the first significant descending gradient in the one or more significant descending extractions is found from the score sequence, and it is determined that a text chunk corresponding to the matching score and a text chunk before the text chunk in the score sequence are more likely to be an answer source of the first question text.

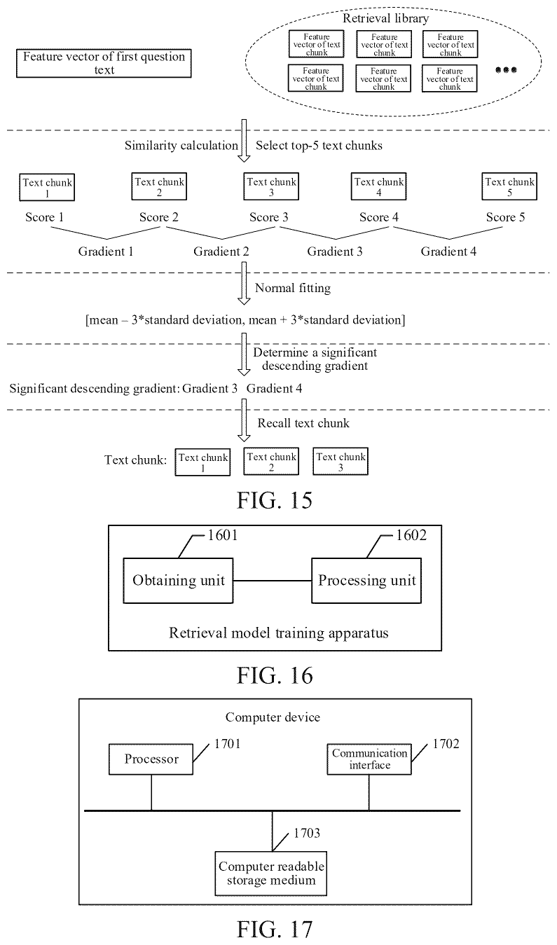

The foregoing descriptions are described by directly sorting the P matching scores corresponding to the P text chunks in the retrieval library. In actual application, to reduce calculation overheads, in this embodiment of this application, specified top-k text chunks (for example, k=10) and matching scores corresponding to the top-k text chunks are supported for output, to implement dynamic recall. For example, as shown in FIG. 15, it is assumed that after similarity calculation processing is performed on the feature vector of the first question text and the feature vectors of the P text chunks in the retrieval library, text chunks corresponding to top-5 matching scores and corresponding matching scores are selected, the text chunks are respectively sorted according to the matching scores as: text chunk 1→text chunk 2→text chunk 3→text chunk 4→text chunk 5, and a score sequence obtained by sorting the matching scores corresponding to the text chunks is: score 1→score 2→score 3→score 4→score 5. Then, gradient information is calculated as a gradient 1, a gradient 2, a gradient 3, and a gradient 4, and normal fitting processing is performed on the gradient information to obtain [mean−3*standard deviation, mean+3*standard deviation]. It is determined that significant descending gradients falling outside [mean−3*standard deviation, mean+3*standard deviation] are the gradient 3 and the gradient 4. Further, it is determined that the first significant descending gradient in the two significant descending gradients is the gradient 3, a matching score corresponding to the first significant descending gradient “the gradient 3” is found from the score sequence as the score 4, and it is determined that the text chunk 3, the text chunk 2, and the text chunk 1 that are before the text chunk 4 corresponding to the score 4 in the score sequence are more likely to be answer sources of the first question text, and it is determined that the recalled text chunks are the text chunk 1, the text chunk 2, and the text chunk 3.

It can be learned that in the text chunk recall manner provided in this embodiment of this application, recalling of the first several text chunks from the retrieval library is not simply limited, but a text chunk is dynamically recalled according to a descending gradient. In addition, when the answer of the first question text is relatively clear, the matching score between the first question text and the text chunk including the answer is significantly increased, and one or more most related text chunks may be returned, thereby further improving recall accuracy, and reducing dillution of redundant answers to effective information.

S1308: Generate the first answer for the first question text based on the text chunk corresponding to the one or more matching scores.

As described in the foregoing related description of the embodiment shown in FIG. 12, answer generation models corresponding to different difficulty levels are further configured in the intelligent question-answering system provided in this embodiment of this application. Therefore, after one or more matching scores that meet the gradient descent condition (specifically, the matching score before the first significant descent gradient) are obtained based on the foregoing operations S1304 to S1307, the one or more matching scores may be allocated, according to the difficulty level of the first question text, to the answer generation model corresponding to the difficulty level, to generate the first answer. During specific implementation, the intelligent question-answering system performs task classification processing on the first question text, to obtain a classification result. The classification result is configured for indicating answer difficulty (that is, the difficulty level mentioned above) of the first question text. Then, the intelligent question-answering system generates, according to the answer difficulty indicated by the classification result, an initial answer of the first question text by using an answer generation model matching the answer difficulty and based on the text chunk corresponding to the one or more matching scores.

Further, to ensure accuracy of the initial answer generated by the answer generation model, this embodiment of this application further supports performing answer quality detection/review on the initial answer, and using a reviewed initial answer as the first answer that matches the first question text. Specifically, the intelligent question-answering system supports performing answer review processing on the initial answer, to obtain the first answer of the first question text. In an actual review process, if the initial answer is an appropriate answer (for example, a style adapts to the first question text), the initial answer is the first answer. If the initial answer is not an appropriate answer, it is determined that an answer obtained after the initial answer is fine-tuned is the first answer. In detail, the intelligent question-answering system may include a quality detection model having a quality detection function. Therefore, the intelligent question-answering system may invoke the quality detection model to perform quality detection on the initial answer. The quality detection herein is mainly inputting the first question text to the quality detection model, so as to check a question style, and when a form or a style of the initial answer is inappropriate, the initial answer is rewritten to obtain the first answer.

Further, conventional question-answering is mainly for a single round of question-answering, and when a plurality of rounds of question-answering are faced, a form of splitting them into a single round is used or a manual policy is usually configured for mandatory intervention. This results in that very important key information is lost between the plurality of rounds of question-answering, an association between the plurality of rounds of question-answering is not strong, and a response is rigid. To improve flexibility and relevance of a plurality of rounds of question-answering, in this embodiment of this application, capabilities such as long memory and extraction of a GPT model are used. Different GPT models are configured for playing a role, and different advantages are exerted at different stages of the plurality of rounds of question-answering with reference to object data of an object, thereby implementing customized answers for different objects.

Using an example in which an interactive dialog scenario includes a plurality of rounds of interactive dialogs, and any round of interactive dialog other than the first round of interactive dialog in the plurality of rounds of interactive dialogs is represented as a target round of interactive dialog, an operation performed by the intelligent question-answering system on the target round of interactive dialog in the plurality of rounds of interactive dialogs may include: first, obtaining a first question text inputted by an object in the target round of interactive dialog, historical dialog data (such as a historical question text and an answer of the historical question text) in a historical round of interactive dialog (such as an interactive dialog located between target round of interactive dialogs in the plurality of rounds of interactive dialogs), and historical object data about an object (such as some personalized data about an object extracted in a historical round of interactive dialog process, such as a query focus of the object and basic information (such as an age and a gender) of the object). The historical object data is generated based on the historical dialog data. Then, question rewriting is performed on a target text question based on the first question text, the historical dialog data, and the historical object data, to obtain a new first question text. In this way, vector embedding processing may be performed on the new first question text by using the second retrieval model, similarity calculation is performed on a feature vector of the new first question text and the feature vector of the text chunk in the retrieval library, to obtain a plurality of matching scores, and a text chunk matching the first question text is selected based on the plurality of matching scores (that is, the specific process shown in the foregoing operations S1304 to S1307). The target round of interactive dialog in the foregoing description is any round of interactive dialog except the first round of interactive dialog in the plurality of rounds of interactive dialogs. Therefore, the first round of interactive dialog in the plurality of rounds of interactive dialog may be used as a single round of interactive dialog, and there is no object data that can be introduced.

As described above, in this embodiment of this application, a plurality of GPT models are configured for implementing different processes of a plurality of rounds of question-answering. The following describes an approximate process of triggering a plurality of rounds of interactive dialogs in an intelligent question-answering system from the perspective of different GPT models:

First, after receiving the first question text, the intelligent question-answering system may input, by using the GPT model A as a process controller, a current question text raised by an object in a current round of interactive dialog process, historical dialog data (if the current round of interactive dialog is the first round, the historical dialog data is null), and historical object data (if the current round of interactive dialog is the first round, the historical object data is null) to a GPT model A. In this way, the GPT model A performs extraction of new object data based on the current question text provided by the object in the current round of interactive dialog process, the historical dialog data, and the historical object data; determines whether the historical object data needs to be updated or added based on the current interactive dialog; and performs question rewriting on the current question text based on the new object data and the current question text, to generate a simple and understandable new question text.

Then, the intelligent question-answering system invokes a second retrieval model to perform vector embedding processing on the new question text, and performs specific operations shown in the foregoing operations S1304 to S1307, to obtain one or more text chunks matching the new question text.

Finally, the intelligent question-answering system uses a GPT model B as a logical question distribution, and determines whether to directly answer a rewritten question (that is, a new question text) directly based on one or more text chunks matching the new question text. If yes, answer difficulty of the new question text is relatively low, for example, questions such as price consultation or insurance policy amount consultation, a GPT model C (a common customer service shown in FIG. 12) is used as a universal responder to directly generate the first answer based on the one or more text chunks matching the new question text for answering. Conversely, if no, the new question text presents an answer difficulty-such as determining whether a particular industry is eligible for insurance coverage. In such cases, it is then assessed whether more specialized logical reasoning is required. If not needed, although the new question text is somewhat challenging to answer, the difficulty level is not high. In this scenario, GPT Model D (i.e., the specialized customer service agent shown in FIG. 12) can be assigned to generate a first answer based on one or more text chunks matching the new question text. If specialized logical reasoning is required, the new question text has a higher difficulty level for answering. In this case, GPT Model E (i.e., the question retrieval model shown in FIG. 12) is employed to perform logical reasoning and output an answer in combination with the object data.

In this embodiment of this application, from the perspective of user experience, the intelligent question-answering system may support a plurality of rounds of interactive dialogs and user-customized recommendation, thereby greatly improving smoothness, naturalness, and accuracy of answers. From an underlying technical level, embodiments of this application at least include the following advantages: 1. A new text segmentation technology is provided from the perspective of text segmentation. The text segmentation technology can ensure that a segmented text chunk has a single topic and carries general information, so that the text chunk has advantages such as a clear topic and a clear logic, thereby improving data quality of a retrieval library constructed based on the text chunk. 2. A new data pair generation solution is proposed from the perspective of data pair generation. Specifically, by using functions and advantages of an emerging technology GPT, a more real and reliable data pair is constructed based on a text chunk, that is, it is ensured that a text chunk in the same data pair is definitely an answer source of a question text. 3. From the perspective of retrieval model training, when a first retrieval model is trained by using a high-quality data pair, the first retrieval model is trained in a direction of reducing a feature difference between a question text and a text chunk in the same data pair is further supported, so that a trained first retrieval model (that is, a second retrieval model) has a better vector expression capability for both the question text and the text chunk, and can make a vector expression of the question text closer to a vector expression of a text chunk of an answer source of the question text. In this way, in a model application process, it is determined that a relatively good and accurate text chunk is matched for the first question text. 4. From the perspective of text chunk recall, the approach supports a dynamic recall count method based on matching scores. This enables dynamically recalling a variable quantity of text chunks for different questions, while ensuring the relevance between the recalled text chunks and their corresponding questions, thereby enhancing the concentration of effective information in the recall results. 5. From the retrieval library, not only storage of a metadata structure for a text chunk in the retrieval library is supported, thereby facilitating index retrieval and update (for example, iterative update) of the retrieval library based on metadata of the text chunk, but also the retrieval library supports a plurality of forms, including a plurality of forms such as a table, a picture, and a video. In conclusion, embodiments of this application support the use of a plurality of GPT models playing different roles to control stages, implement functions, and conduct response quality inspection, among other tasks. This approach aims to enhance the retrieval capability, stage control capability, and sustainable iteration capability (such as multi-turn question-answering combined with object data) of the intelligent question-answering system across various stages, thereby generating sustainable and iterative solutions.

The foregoing describes in detail the methods in the embodiments of this application. To better implement the foregoing solutions in the embodiments of this application, correspondingly, the following provides apparatuses in the embodiments of this application. In embodiments of this application, the term “module” or “unit” refers to a computer program having a predetermined function or a part of a computer program, and works together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or the unit.

FIG. 16 is a schematic structural diagram of a retrieval model training apparatus according to an exemplary embodiment of this application. The retrieval model training apparatus may be configured to perform some or all operations in the method embodiment shown in FIG. 5 or FIG. 13. Referring to FIG. 16, the apparatus includes the following units:
an obtaining unit 1601, configured to obtain a knowledge document, and perform text segmentation processing on the knowledge document, to obtain a text chunk set, the text chunk set including a plurality of text chunks, each text chunk being formed by one reference text chunk belonging to the knowledge document and general information corresponding to the reference text chunk, and the general information being obtained by summarizing text semantics of the corresponding reference text chunk; and
a processing unit 1602, configured to perform question writing on each text chunk based on the text chunk set and the general information included in each text chunk, to obtain one or more question texts corresponding to each text chunk; combine the one or more question texts corresponding to each text chunk with the corresponding text chunk separately, to obtain one or more data pairs corresponding to each text chunk; and generate a data pair set based on the one or more data pairs corresponding to each text chunk, each data pair being formed by one question text and one text chunk that are matched, and a text chunk in each data pair being used as an answer source of a question text matching the text chunk;
where the processing unit 1602 is further configured to train a first retrieval model by using the data pair set, to obtain a second retrieval model, the training being configured for making a feature difference between a question text and a text chunk that are matched in each data pair less than a preset threshold, the second retrieval model being corresponding to a retrieval library, the retrieval library including a feature vector of each text chunk in the text chunk set, and the second retrieval model and the retrieval library being configured for generating a first answer for a first question text in an interactive dialog scenario.

In an implementation, there is at least one knowledge document. When performing text segmentation processing on the knowledge document, to obtain the text chunk set, the processing unit 1602 is specifically configured to: obtain semantic information of the knowledge document, and perform segmentation processing on the knowledge document based on the semantic information of the knowledge document, to obtain one or more reference text chunks corresponding to the knowledge document; perform semantic summarization on text semantics of each reference text chunk of the one or more reference text chunks, to obtain general information corresponding to each reference text chunk; and add the general information corresponding to each reference text chunk to a target position in the corresponding reference text chunk, to obtain a text chunk corresponding to each reference text chunk, the text chunk corresponding to each reference text chunk forming the text chunk set.

In an implementation, the semantic information of the knowledge document includes a topic to which the knowledge document belongs, and the knowledge document is formed by one or more characters. When performing segmentation processing on the knowledge document based on the semantic information of the knowledge document, to obtain the one or more reference text chunks corresponding to the knowledge document, the processing unit 1602 is specifically configured to: count, if the knowledge document belongs to a single topic, a character quantity of characters included in the knowledge document; and use the knowledge document as one reference text chunk when the character quantity of the characters included in the knowledge document is less than a character quantity threshold; or perform paragraph segmentation processing on the knowledge document according to a text logical relationship when the character quantity of the characters included in the knowledge document is greater than or equal to the character quantity threshold, to obtain a plurality of reference text chunks corresponding to the knowledge document.

In an implementation, the processing unit 1602 is further configured to: perform hierarchical expression segmentation on the knowledge document if there are at least two topics to which the knowledge document belongs, to obtain at least two initial text chunks, the at least two initial text chunks respectively having one topic; count a character quantity of characters included in each initial text chunk of the at least two initial text chunks, and use an initial text chunk whose character quantity is less than the character quantity threshold as a reference text chunk; and perform paragraph segmentation processing on an initial text chunk whose character quantity is greater than or equal to the character quantity threshold according to a text logical relationship, to obtain a plurality of reference text chunks corresponding to the knowledge document.

In an implementation, the knowledge document or the initial text chunk on which the paragraph segmentation processing is performed is represented as text content; the text logical relationship is a general-to-specific relationship or a parallel relationship; the general-to-specific relationship indicates that a content structure of the text content is a general-to-specific structure, and the parallel relationship indicates that the content structure of the text content is a parallel structure; and the paragraph segmentation processing includes: performing paragraph segmentation processing on the text content according to the text logical relationship of the text content, to obtain a reference text chunk corresponding to the knowledge document; where when the text logical relationship of the text content is the general-to-specific relationship, the text content is segmented into a general text chunk and one or more specific text chunks; the general text chunk is content having a general effect in the text content, and general information corresponding to the general text chunk is configured for indicating overall semantics expressed by the text content; and the specific text chunk is content that is in the text content and that has an explanation effect on the general text chunk, and general information corresponding to the specific text chunk is configured for indicating specific semantics expressed by the specific text chunk and overall semantics expressed by the text content; and the text content is segmented into at least two specific text chunks when the text logical relationship is a parallel relationship.

In an implementation, the processing unit 1602 is further configured to: perform metadata extraction on each text chunk in the text chunk set, to obtain metadata of each text chunk, the metadata of the text chunk being configured for describing a data property of the text chunk, and the data property including: a retrieval field to which the text chunk belongs, a source of the text chunk, and a topic to which the text chunk belongs; where the metadata of each text chunk is configured for updating the retrieval library and performing index retrieval on the text chunk, and the updating includes: when a data property of a text chunk in the retrieval library is updated, modifying a property value of the corresponding data property in metadata of the text chunk; and the index retrieval includes at least: retrieving, from metadata according to a retrieval requirement indicated by the first question text in the interactive dialog scenario, a text chunk whose metadata meets the retrieval requirement, to generate an answer for the first question text; retrieve, from the metadata when any text chunk has been retrieved in the interactive dialog scenario, a text chunk whose metadata is the same as metadata of the any text chunk, to generate an answer for the first question text.

In an implementation, when generating the data pair set based on the text chunk set and the general information included in each text chunk, the processing unit 1602 is specifically configured to: obtain scenario information corresponding to the interactive dialog scenario, the scenario information including a dialog style, an interaction manner, and an interaction field; determine, based on the scenario information, the text chunk set, and the general information included in each text chunk, a question style and a question quantity that match each text chunk; and perform question writing on each text chunk according to the question style and the question quantity that match each text chunk, to obtain one or more question texts corresponding to each text chunk.

In an implementation, when determining, based on the scenario information, the text chunk set, and the general information included in each text chunk, a question style and a question quantity that match each text chunk, the processing unit 1602 is specifically configured to: perform key element mining on each text chunk according to the text chunk set and the general information included in each text chunk, to obtain a key element of each text chunk; and determine, based on the scenario information and the key element of each text chunk, the question style and the question quantity that match each text chunk.

In an implementation, any text chunk in the text chunk set is represented as a first text chunk, any data pair corresponding to the first text chunk is represented as a first data pair, and the first data pair includes a first question text that matches the first text chunk. When generating the data pair set based on the one or more data pairs corresponding to each text chunk, the processing unit 1602 is specifically configured to: extract, from the first text chunk based on the first question text by using a key pair verification model, a first answer that matches the first question text and position information of the first answer in the first text chunk; extract, from the first text chunk according to the position information of the first answer in the first text chunk, a second answer indicated by the position information; and add the first data pair to the data pair set if the first answer is the same as the second answer or not add the first data pair to the data pair set if the first answer is not the same as the second answer.

In an implementation, the text chunk set includes a candidate text chunk, the candidate text chunk is a text chunk whose format conforms to a question-answer structure, and the candidate text chunk includes a question part and an answer part. The processing unit 1602 is further configured to: add the candidate text chunk to the data pair set; and perform question generalization processing on the question part included in the candidate text chunk, to generate a generalized question text, form a new data pair corresponding to the candidate text chunk by using the generalized question text and the answer part included in the candidate text chunk, and add the new data pair to the data pair set.

In an implementation, when training the first retrieval model by using the data pair set, to obtain the second retrieval model, the processing unit 1602 is specifically configured to: perform data allocation processing on the data pair set according to a data allocation policy, to obtain a first data pair set and a second data pair set, the data allocation policy including an answer layering policy and a word embedding classification policy, the first data pair set being a verification set, and the second data pair set being a training set; or the first data pair set being a training set, and the second data pair set being a verification set; train the first retrieval model by using the training set, to obtain a trained first retrieval model; and test the trained first retrieval model by using the verification set, to obtain the second retrieval model.

In an implementation, the data allocation policy is an answer layering policy; any text chunk in the text chunk set is represented as a first text chunk, and the first text chunk is corresponding to Q first data pairs, Q being an integer greater than 0. When performing data allocation processing on the data pair set according to the data allocation policy, to obtain the first data pair set and the second data pair set, the processing unit 1602 is specifically configured to: determine position information that is of an answer corresponding to a question text in each first data pair of the Q first data pairs and that is in the first text chunk; perform layered processing on the first text chunk according to the position information that is of the answer corresponding to the question text in each first data pair and that is in the first text chunk, to obtain a plurality of text sublayers corresponding to the first text chunk, one text sublayer being corresponding to at least one first data pair of the Q first data pairs; select a reference data pair from the first data pair corresponding to each text sublayer of the plurality of text sublayers and add the reference data pair to the first data pair set, and add a first data pair other than the selected reference data pair in the plurality of text sublayers to the second data pair set.

In an implementation, the data allocation policy is a word embedding classification policy; any text chunk in the text chunk set is represented as a first text chunk, the first text chunk is corresponding to Q first data pairs, Q is an integer greater than 0, and a question text in the first data pair is formed by one or more characters. When performing data allocation processing on the data pair set according to the data allocation policy, to obtain the first data pair set and the second data pair set, the processing unit 1602 is specifically configured to: separately perform word vector representation on Q question texts in the Q first data pairs, to obtain a word vector corresponding to each question text of the Q question texts, a vector distance between word vectors corresponding to different question texts being configured for indicating a similarity between the different question texts; clustering the word vectors corresponding to the Q question texts, to obtain one or more cluster groups, one cluster group including first data pairs corresponding to one or more question texts whose vector distances meet a distance requirement; and select a reference data pair from the one or more cluster groups and add the reference data pair to the first data pair set, and add a first data pair other than the selected reference data pair in the one or more cluster groups to the second data pair set.

In an implementation, the retrieval library includes feature vectors of P text chunks, P is a positive integer, and P is less than Q. The processing unit 1602 is further configured to: receive, in the interactive dialog scenario, a first question text inputted by an object, and perform vector embedding processing on the first question text by using the second retrieval model, to obtain a feature vector of the first question text, the feature vector of the first question text being configured for representing semantic information of the first question text; perform similarity calculation processing on the feature vector of the first question text and the feature vectors of the P text chunks in the retrieval library, to obtain matching scores respectively between the P text chunks and the first question text, the matching score being configured for indicating credibility that a text chunk is used as an answer source of the first question text; sort the P matching scores in descending order, and perform a gradient operation on each matching score in a sorted score sequence, to obtain a plurality of pieces of gradient information; dynamically select, based on the plurality of pieces of gradient information, one or more matching scores whose gradient information meets a gradient descent condition from the score sequence, and use a text chunk corresponding to the one or more matching scores as the answer source of the first question text; and generate the first answer for the first question text based on the text chunk corresponding to the one or more matching scores.

In an implementation, when generating the first answer for the first question text based on the text chunks corresponding to the one or more matching scores, the processing unit 1602 is specifically configured to: perform task classification processing on the first question text, to obtain a classification result, the classification result being configured for indicating answer difficulty of the first question text; generate, according to the answer difficulty indicated by the classification result, an initial answer of the first question text by using an answer generation model matching the answer difficulty and based on the text chunk corresponding to the one or more matching scores; and perform answer review processing on the initial answer, to obtain a first answer of the first question text, the first answer being the initial answer or an answer obtained after the initial answer is fine-tuned.

In an implementation, the interactive dialog scenario includes a plurality of rounds of interactive dialogs, and any round of interactive dialog other than the first round of interactive dialog in the plurality of rounds of interactive dialogs is represented as a target round of interactive dialog. The processing unit 1602 is further configured to: obtain the first question text inputted by the object in the target round of interactive dialog, historical dialog data in a historical round of interactive dialog, and historical object data about the object, the historical object data being generated based on the historical dialog data; and perform question rewriting on a target text question based on the first question text, the historical dialog data, and the historical object data, to obtain a new first question text. When performing vector embedding processing on the first question text by using the second retrieval model, the processing unit 1602 is specifically configured to: perform vector embedding processing on the new first question text by using the second retrieval model.

According to an embodiment of this application, units of the retrieval model training apparatus shown in FIG. 16 may be separately or wholly combined into one or several other units, or one (or more) of the units herein may further be divided into a plurality of units of smaller functions. In this way, the same operations can be implemented, and implementation of the technical effects of the embodiments of this application is not affected. The foregoing units are divided based on logical functions. In an actual application, a function of one unit may be implemented by a plurality of units, or functions of a plurality of units are implemented by one unit. In another embodiment of this application, the retrieval model training apparatus may alternatively include other units. In actual application, these functions may be implemented with the assistance of other units, and may be cooperatively implemented by a plurality of units. According to another embodiment of this application, the retrieval model training apparatus shown in FIG. 16 may be constructed and the retrieval model training method in embodiments of this application may be implemented by running a computer program (including program code) that can perform the operations involved in the corresponding methods shown in FIG. 5 and FIG. 13 on a general-purpose computing device such as a computer that includes processing elements and storage elements such as a central processing unit (CPU), a random access memory (RAM), and a read-only memory (ROM). The computer program may be recorded in, for example, a computer readable recording medium, and may be loaded into the foregoing computing device by using the computer readable recording medium, and run in the computing device.

In embodiments of this application, after the knowledge document in the vertical field is obtained, first, text segmentation processing may be performed on the knowledge document, to obtain a text chunk set including a plurality of text chunks. Each text chunk has a topic, to ensure a clear topic of each document chunk. In addition, each text chunk not only includes a reference text chunk belonging to the knowledge document, but also includes general information configured for summarizing text semantics of the reference text chunk, so that each text chunk has an advantage of a clear logic. Then, generation of a data pair set including a plurality of data pairs based on a text chunk set, specifically, a text chunk in the text chunk set is supported. Each data pair includes a question text and a text chunk, and the question text in each data pair is obtained by performing question writing on the text chunk matching the question text, thereby greatly improving question production, and the text chunk of each data pair is used as an answer source of the question text matching the question text, thereby ensuring authenticity and availability of the data pair. Finally, the first retrieval model may be trained by using the data pair set, to obtain the second retrieval model and the retrieval library (including a feature vector obtained by performing vector embedding processing on each text chunk by using the second retrieval model). In a training process, a feature difference between the question text and the text chunk that match each data pair needs to be less than a preset threshold, to ensure that features of the question text and the text chunk in the same data pair are similar, so that during subsequent answer retrieval, when a feature of the first question text is mapped to a retrieval library with better data quality, a text chunk with a similar feature can be found from the retrieval library to generate the first answer for the first question text, thereby improving accuracy and professionalism of answer retrieval in an intelligent question-answering process.

FIG. 17 is a schematic structural diagram of a computer device according to an exemplary embodiment of this application. Referring to FIG. 17, the computer device includes a processor 1701, a communication interface 1702, and a computer readable storage medium 1703. The processor 1701, the communication interface 1702, and the computer readable storage medium 1703 may be connected by using a bus or in another manner. The communication interface 1702 is configured to receive and transmit data. The computer readable storage medium 1703 may be stored in a memory of the computer device. The computer readable storage medium 1703 is configured to store a computer program. The computer program includes program instructions. The processor 1701 is configured to execute the program instructions stored in the computer readable storage medium 1703. As a computing core and a control core of the computer device, the processor 1701 (or referred to as a CPU) is adapted to implementing one or more instructions, specifically adapted to loading and executing the one or more instructions, to implement corresponding method procedures or corresponding functions.

An embodiment of this application further provides a computer readable storage medium (Memory). The computer readable storage medium is a memory device in a computer device, and is configured to store a program and data. The computer readable storage medium herein may include a built-in storage medium in the computer device, and certainly may also include an extended storage medium supported by the computer device. The computer readable storage medium provides storage space, and the storage space stores a processing system of the computer device. In addition, one or more instructions suitable for being loaded and executed by the processor 1701 are further stored in the storage space. These instructions may be one or more computer programs (including program code). The computer readable storage medium herein may be a high-speed RAM memory, or may be a non-volatile memory, for example, at least one magnetic disk memory. In some embodiments, the computer readable storage medium may further be at least one computer readable storage medium located far away from the foregoing processor.

In an embodiment, the computer readable storage medium stores one or more instructions, and the processor 1401 loads and executes the one or more instructions stored in the computer readable storage medium, so as to implement corresponding operations in the foregoing retrieval model training method embodiment.

Based on the same inventive concept, the problem-solving principle and beneficial effects of the computer device provided in embodiments of this application are similar to those of the retrieval model training method in method embodiments of this application. Refer to the principle and beneficial effects of the implementation of the method. For brevity, details are not described herein again.

An embodiment of this application provides a computer program product or a computer program. The computer program product or the computer program includes computer instructions, and the computer instructions are stored in a computer readable storage medium. A processor of a computer device reads the computer instructions from the computer readable storage medium, and the processor executes the computer instructions, so that the computer device performs the retrieval model training method provided in the foregoing.

A person of ordinary skill in the art may be aware that the example units and algorithm operations described with reference to embodiments disclosed in this specification may be implemented by electronic hardware, or a combination of computer software and electronic hardware. Whether the functions are executed in a mode of hardware or software depends on particular applications and design constraint conditions of the technical solutions. Those skilled in the art may use different methods to implement the described functions for each particular application, but such implementation is not to be considered beyond the scope of this application.

In the foregoing embodiments, software, hardware, firmware, or any combination thereof may be configured for implementation in whole or in part. When software is configured for implementation, implementation may be entirely or partially performed in the form of a computer program product. The computer program product includes one or more computer instructions. When the computer program instructions are loaded and executed on a computer, all or some of the processes or functions described in the embodiments of this application are generated. The computer may be a general-purpose computer, a special-purpose computer, a computer network, or another programmable device. The computer instructions may be stored in a computer readable storage medium, or transmitted by using the computer readable storage medium. The computer instructions may be transmitted from one website, computer, server or data center to another website, computer, server or data center in a wired (for example, a coaxial cable, an optical fiber or a digital subscriber line (DSL)) or wireless (for example, infrared, wireless or microwave) manner. The computer readable storage medium may be any available medium capable of being accessed by a computer or include one or more data processing devices integrated by an available medium, such as a server and a data center. The available medium may be a magnetic medium (such as a floppy disk, a hard disk, or a magnetic tape), an optical medium (such as a DVD), a semiconductor medium (such as a solid state disk (SSD)) or the like.

Technical features of the foregoing embodiments may be combined in different manners to form other embodiments. To make description concise, not all possible combinations of the technical features in the foregoing embodiments are described. However, the combinations of these technical features shall be considered as falling within the scope recorded by this specification provided that no conflict exists.

The foregoing embodiments merely express several implementations of this application. The descriptions thereof are relatively specific and detailed, but are not to be understood as limitations to the patent scope of the present disclosure. For a person of ordinary skill in the art, several transformations and improvements can be made without departing from the idea of this application. These transformations and improvements belong to the protection scope of this application. Therefore, the protection scope of the patent of this application shall be topic to the appended claims.

What is claimed is:

1. A retrieval model training method performed by a computer device, the method comprising:
performing text segmentation processing on a knowledge document, to obtain a text chunk set, the text chunk set comprising a plurality of text chunks, each text chunk being formed by one reference text chunk belonging to the knowledge document and general information corresponding to the reference text chunk;
performing question writing on each text chunk based on the text chunk set and the general information comprised in each text chunk, to obtain one or more question texts corresponding to the text chunk;
combining the one or more question texts corresponding to each text chunk with the corresponding text chunk separately, to obtain one or more data pairs corresponding to each text chunk;
generating a data pair set based on the one or more data pairs corresponding to each text chunk, each data pair being formed by one question text and one text chunk that are matched, and a text chunk in each data pair being used as an answer source of a question text matching the text chunk; and
training a first retrieval model by using the data pair set, to obtain a second retrieval model, the second retrieval model corresponding to a retrieval library, the retrieval library comprising a feature vector of each text chunk in the text chunk set configured for generating a first answer for a first question text matching the text chunk in an interactive dialog scenario.

2. The method according to claim 1, wherein the general information is generated by summarizing text semantics of the corresponding reference text chunk.

3. The method according to claim 1, wherein a feature difference between a question text and a text chunk that are matched in each data pair is less than a preset threshold.

4. The method according to claim 1, wherein there is at least one knowledge document; and the performing text segmentation processing on the knowledge document, to obtain a text chunk set comprises:
obtaining semantic information of the knowledge document, and performing segmentation processing on the knowledge document based on the semantic information of the knowledge document, to obtain one or more reference text chunks corresponding to the knowledge document;
performing semantic summarization on text semantics of each reference text chunk of the one or more reference text chunks, to obtain general information corresponding to each reference text chunk; and
adding the general information corresponding to each reference text chunk to a target position in the corresponding reference text chunk, to obtain a text chunk corresponding to each reference text chunk, the text chunk corresponding to each reference text chunk forming the text chunk set.

5. The method according to claim 1, wherein after the performing text segmentation processing on the knowledge document, to obtain a text chunk set, the method further comprises:
performing metadata extraction on each text chunk in the text chunk set, to obtain metadata of each text chunk, the metadata of the text chunk being configured for describing a data property of the text chunk, and the data property comprising: a retrieval field to which the text chunk belongs, a source of the text chunk, and a topic to which the text chunk belongs;
wherein the metadata of each text chunk is configured for updating the retrieval library and performing index retrieval on the text chunk, and the updating comprises: when a data property of a text chunk in the retrieval library is updated, modifying a property value of the corresponding data property in metadata of the text chunk; and
the index retrieval comprises: retrieving, from metadata according to a retrieval requirement indicated by the first question text in the interactive dialog scenario, a text chunk whose metadata meets the retrieval requirement, to generate an answer for the first question text.

6. The method according to claim 1, wherein the performing question writing on each text chunk based on the text chunk set and the general information comprised in each text chunk, to obtain one or more question texts corresponding to each text chunk comprises:
obtaining scenario information corresponding to the interactive dialog scenario, the scenario information comprising a dialog style, an interaction manner, and an interaction field;
determining, based on the scenario information, the text chunk set, and the general information comprised in each text chunk, a question style and a question quantity that match each text chunk; and
performing question writing on each text chunk according to the question style and the question quantity that match each text chunk, to obtain one or more question texts corresponding to each text chunk.

7. The method according to claim 1, wherein any text chunk in the text chunk set is represented as a first text chunk, any data pair corresponding to the first text chunk is represented as a first data pair, and the first data pair comprises a first question text that matches the first text chunk; and the generating a data pair set based on the one or more data pairs corresponding to each text chunk comprises:
extracting, from the first text chunk based on the first question text by using a key pair verification model, a first answer that matches the first question text and position information of the first answer in the first text chunk;
extracting, from the first text chunk according to the position information of the first answer in the first text chunk, a second answer indicated by the position information; and
adding the first data pair to the data pair set if the first answer is the same as the second answer.

8. The method according to claim 1, wherein the text chunk set comprises a candidate text chunk, the candidate text chunk is a text chunk whose format conforms to a question-answer structure, and the candidate text chunk comprises a question part and an answer part; and the method further comprises:
adding the candidate text chunk to the data pair set; and
performing question generalization processing on the question part comprised in the candidate text chunk, to generate a generalized question text, forming a new data pair corresponding to the candidate text chunk by using the generalized question text and the answer part comprised in the candidate text chunk, and adding the new data pair to the data pair set.

9. The method according to claim 1, wherein the training a first retrieval model by using the data pair set, to obtain a second retrieval model comprises:
performing data allocation processing on the data pair set according to a data allocation policy, to obtain a first data pair set and a second data pair set, the first data pair set being a verification set, and the second data pair set being a training set; or the first data pair set being a training set, and the second data pair set being a verification set;
training the first retrieval model by using the training set, to obtain a trained first retrieval model; and
testing the trained first retrieval model by using the verification set, to obtain the second retrieval model.

10. The method according to claim 1, wherein the retrieval library comprises feature vectors of P text chunks, P is a positive integer, and P is less than Q; and the method further comprises:
receiving, in the interactive dialog scenario, a first question text inputted by an object, and performing vector embedding processing on the first question text by using the second retrieval model, to obtain a feature vector of the first question text, the feature vector of the first question text being configured for representing semantic information of the first question text;
performing similarity calculation processing on the feature vector of the first question text and the feature vectors of the P text chunks in the retrieval library, to obtain matching scores respectively between the P text chunks and the first question text, the matching score being configured for indicating credibility that a text chunk is used as an answer source of the first question text;
sorting the P matching scores in descending order, and performing a gradient operation on each matching score in a sorted score sequence, to obtain a plurality of pieces of gradient information;
dynamically selecting, based on the plurality of pieces of gradient information, one or more matching scores whose gradient information meets a gradient descent condition from the score sequence, and using a text chunk corresponding to the one or more matching scores as the answer source of the first question text; and
generating the first answer for the first question text based on the text chunk corresponding to the one or more matching scores.

11. A computer device, comprising:
a processor, adapted to execute a computer program; and
a computer readable storage medium, having a computer program stored therein, the computer program, when executed by the processor, causing the computer device to perform a retrieval model training method including: performing text segmentation processing on a knowledge document, to obtain a text chunk set, the text chunk set comprising a plurality of text chunks, each text chunk being formed by one reference text chunk belonging to the knowledge document and general information corresponding to the reference text chunk;
performing question writing on each text chunk based on the text chunk set and the general information comprised in each text chunk, to obtain one or more question texts corresponding to the text chunk;
combining the one or more question texts corresponding to each text chunk with the corresponding text chunk separately, to obtain one or more data pairs corresponding to each text chunk;
generating a data pair set based on the one or more data pairs corresponding to each text chunk, each data pair being formed by one question text and one text chunk that are matched, and a text chunk in each data pair being used as an answer source of a question text matching the text chunk; and
training a first retrieval model by using the data pair set, to obtain a second retrieval model, the second retrieval model corresponding to a retrieval library, the retrieval library comprising a feature vector of each text chunk in the text chunk set configured for generating a first answer for a first question text matching the text chunk in an interactive dialog scenario.

12. The computer device according to claim 11, wherein the general information is generated by summarizing text semantics of the corresponding reference text chunk.

13. The computer device according to claim 11, wherein a feature difference between a question text and a text chunk that are matched in each data pair is less than a preset threshold.

14. The computer device according to claim 11, wherein after the performing text segmentation processing on the knowledge document, to obtain a text chunk set, the method further comprises:
performing metadata extraction on each text chunk in the text chunk set, to obtain metadata of each text chunk, the metadata of the text chunk being configured for describing a data property of the text chunk, and the data property comprising: a retrieval field to which the text chunk belongs, a source of the text chunk, and a topic to which the text chunk belongs;
wherein the metadata of each text chunk is configured for updating the retrieval library and performing index retrieval on the text chunk, and the updating comprises: when a data property of a text chunk in the retrieval library is updated, modifying a property value of the corresponding data property in metadata of the text chunk; and
the index retrieval comprises: retrieving, from metadata according to a retrieval requirement indicated by the first question text in the interactive dialog scenario, a text chunk whose metadata meets the retrieval requirement, to generate an answer for the first question text.

15. The computer device according to claim 11, wherein the performing question writing on each text chunk based on the text chunk set and the general information comprised in each text chunk, to obtain one or more question texts corresponding to each text chunk comprises:
obtaining scenario information corresponding to the interactive dialog scenario, the scenario information comprising a dialog style, an interaction manner, and an interaction field;
determining, based on the scenario information, the text chunk set, and the general information comprised in each text chunk, a question style and a question quantity that match each text chunk; and
performing question writing on each text chunk according to the question style and the question quantity that match each text chunk, to obtain one or more question texts corresponding to each text chunk.

16. The computer device according to claim 11, wherein any text chunk in the text chunk set is represented as a first text chunk, any data pair corresponding to the first text chunk is represented as a first data pair, and the first data pair comprises a first question text that matches the first text chunk; and the generating a data pair set based on the one or more data pairs corresponding to each text chunk comprises:
extracting, from the first text chunk based on the first question text by using a key pair verification model, a first answer that matches the first question text and position information of the first answer in the first text chunk;
extracting, from the first text chunk according to the position information of the first answer in the first text chunk, a second answer indicated by the position information; and
adding the first data pair to the data pair set if the first answer is the same as the second answer.

17. The computer device according to claim 11, wherein the text chunk set comprises a candidate text chunk, the candidate text chunk is a text chunk whose format conforms to a question-answer structure, and the candidate text chunk comprises a question part and an answer part; and the method further comprises:
adding the candidate text chunk to the data pair set; and
performing question generalization processing on the question part comprised in the candidate text chunk, to generate a generalized question text, forming a new data pair corresponding to the candidate text chunk by using the generalized question text and the answer part comprised in the candidate text chunk, and adding the new data pair to the data pair set.

18. The computer device according to claim 11, wherein the training a first retrieval model by using the data pair set, to obtain a second retrieval model comprises:
performing data allocation processing on the data pair set according to a data allocation policy, to obtain a first data pair set and a second data pair set, the first data pair set being a verification set, and the second data pair set being a training set; or the first data pair set being a training set, and the second data pair set being a verification set;
training the first retrieval model by using the training set, to obtain a trained first retrieval model; and
testing the trained first retrieval model by using the verification set, to obtain the second retrieval model.

19. The computer device according to claim 11, wherein the retrieval library comprises feature vectors of P text chunks, P is a positive integer, and P is less than Q; and the method further comprises:
receiving, in the interactive dialog scenario, a first question text inputted by an object, and performing vector embedding processing on the first question text by using the second retrieval model, to obtain a feature vector of the first question text, the feature vector of the first question text being configured for representing semantic information of the first question text;
performing similarity calculation processing on the feature vector of the first question text and the feature vectors of the P text chunks in the retrieval library, to obtain matching scores respectively between the P text chunks and the first question text, the matching score being configured for indicating credibility that a text chunk is used as an answer source of the first question text;
sorting the P matching scores in descending order, and performing a gradient operation on each matching score in a sorted score sequence, to obtain a plurality of pieces of gradient information;
dynamically selecting, based on the plurality of pieces of gradient information, one or more matching scores whose gradient information meets a gradient descent condition from the score sequence, and using a text chunk corresponding to the one or more matching scores as the answer source of the first question text; and
generating the first answer for the first question text based on the text chunk corresponding to the one or more matching scores.

20. A non-transitory computer-readable storage medium storing a computer program therein; the computer program, when executed by a processor of a computer device, causing the computer device to perform a retrieval model training method including:
performing text segmentation processing on a knowledge document, to obtain a text chunk set, the text chunk set comprising a plurality of text chunks, each text chunk being formed by one reference text chunk belonging to the knowledge document and general information corresponding to the reference text chunk;
performing question writing on each text chunk based on the text chunk set and the general information comprised in each text chunk, to obtain one or more question texts corresponding to the text chunk;
combining the one or more question texts corresponding to each text chunk with the corresponding text chunk separately, to obtain one or more data pairs corresponding to each text chunk;
generating a data pair set based on the one or more data pairs corresponding to each text chunk, each data pair being formed by one question text and one text chunk that are matched, and a text chunk in each data pair being used as an answer source of a question text matching the text chunk; and
training a first retrieval model by using the data pair set, to obtain a second retrieval model, the second retrieval model corresponding to a retrieval library, the retrieval library comprising a feature vector of each text chunk in the text chunk set configured for generating a first answer for a first question text matching the text chunk in an interactive dialog scenario.
